(19) United States
(12) Patent Application Publication
(10) Pub. No.: US 2020/0388268 A1
(43) Pub. Date: Dec. 10, 2020

(54) INFORMATION PROCESSING APPARATUS, INFORMATION PROCESSING SYSTEM, AND INFORMATION PROCESSING METHOD, AND PROGRAM

(71) Applicant: SONY CORPORATION, TOKYO (JP)

(72) Inventor: MARI SAITO, KANAGAWA (JP)

(21) Appl. No.: 16/959,577

(22) PCT Filed: Oct. 26, 2018
(86) PCT No.: PCT/JP2018/039827

§ 371 Date: Jul. 1, 2020

(30) Foreign Application Priority Data
Jan. 10, 2018 (JP) 2018-002163

(51) Int. Cl. G10L 13/033; G10L 15/22; G10L 15/18; G10L 21/034; G10L 25/51; G06F 3/16

(52) U.S. Cl. CPC G10L 13/033; G10L 15/22; G10L 15/1815; G10L 21/034; G10L 2015/228; G06F 3/167; G06F 3/165; G10L 2015/223; G10L 25/51

(57) ABSTRACT

To implement an apparatus and method capable of outputting the system utterance at optimal volume by controlling the volume of system utterance on the basis of user distance, user utterance volume, ambient volume, and the like. The output control unit executes volume control of system utterance on the basis of a combination of a user distance that is a distance from the information processing apparatus to a user and user utterance volume that is calculated on the basis of user utterance input by the information processing apparatus. The system utterance volume is increased in the case where the user utterance volume is higher than the ordinary volume corresponding to the user distance, and the system utterance volume is decreased in the case where the user utterance volume is lower than the ordinary volume. In addition, control is performed to make the system utterance volume higher than the volume level of the ambient sound.

### TECHNICAL FIELD

The present disclosure relates to information processing apparatuses, information processing systems, and information processing methods, and programs. More specifically, the present disclosure relates to an information processing apparatus, an information processing system, and an information processing method, and a program that perform processing and responses based on a speech recognition result of user utterance.

### BACKGROUND ART

Recently, there has been increasing use of a speech recognition system that performs speech recognition of user utterance and performs various processing and responses based on a recognition result.

Such a speech recognition system recognizes and understands the user utterance input via a microphone and performs processing corresponding on the recognized and understood result.

For example, in a case where the user gives utterance of “tell me the tomorrow's weather”, the processing is performed to acquire weather information from a weather information-providing server, generate a system response based on the acquired information, and output the generated response from a speaker. Specifically, in one example,

system utterance such as “Tomorrow's weather is fine, but there may be a thunderstorm in the evening”,

such a system utterance is output.

Many existing devices, however, output this system utterance at fixed volume or at volume preset by the user.

The system utterance thus is difficult to listen to depending on situations in some cases such as in a case where ambient sound is loud or in a case where the user is talking to someone else.

Furthermore, many devices of outputting system utterance are equipped with a function of playing back music such as BGM, for example. Moreover, there is also a configuration of outputting various sound effects and alarms at various timings such as upon receiving a message or email.

In such a device, if other sounds such as music are output together with system utterance during system utterance execution, the user is difficult to listen to the system utterance.

Further, in a case where the user who is listening to the system utterance is at a position away from a device outputting system utterance, it is also difficult to listen to the system utterance.

Moreover, Patent Document 1 (Japanese Patent Application Laid-Open No. 2005-202076) discloses a configuration in which the volume or rate of the system utterance is adjusted depending on the distance between a device outputting system utterance and the user.

In one example, the configuration is to increase the volume of system utterance in the case where the user is far from the device.

The optimal volume of system utterance, however, is not decided only by the distance between the device and the user. In one example, the optimum volume varies depending on the ambient noise situations. In addition, the optimum volume varies depending on each individual user.

### CITATION LIST

### Patent Document

Patent Document 1: Japanese Patent Application Laid-Open No. 2005-202076

### SUMMARY OF THE INVENTION

### Problems to be Solved by the Invention

The present disclosure is made in view of, in one example, the above problems and is intended to provide an information processing apparatus, an information processing system, and an information processing method, and a program, capable of outputting system utterance at optimum volume depending on various contexts or individuals.

### Solutions to Problems

According to a first aspect of the present disclosure,

there is provided an information processing apparatus including:

an output control unit configured to execute volume control of system utterance

on the basis of a combination of a user distance and user utterance volume, the user distance being a distance from the information processing apparatus to a user,

and the user utterance volume being calculated on the basis of user utterance input by the information processing apparatus.

Further, according to a second aspect of the present disclosure,

there is provided an information processing system including: a user terminal; and a data processing server;

in which the user terminal includes

a speech input unit configured to input user utterance,

an output control unit configured to execute volume control of system utterance, and

a speech output unit configured to output the system utterance,

the data processing server includes

an utterance intention analysis unit configured to analyze intention of the user utterance received from the user terminal,

the user terminal outputs the system utterance depending on the intention of the user utterance through the speech output unit, and

the output control unit of the user terminal

executes volume control of the system utterance on the basis of a combination of a user distance and a user utterance volume,

the user distance being a distance from the user terminal to a user, and the user utterance volume being calculated on the basis of user utterance input through the speech input unit.

Further, according to a third aspect of the present disclosure,

there is provided an information processing method executed in an information processing apparatus including:

an output control unit configured to execute volume control of system utterance,

in which the output control unit executes the volume control of the system utterance on the basis of a combination of a user distance and a user utterance volume,

the user distance being a distance from the information processing apparatus to a user, and

the user utterance volume being calculated on the basis of user utterance input by the information processing apparatus.

Further, according to a fourth aspect of the present disclosure,

there is provided an information processing method executed in an information processing system including: a user terminal; and a data processing server,

in which the user terminal

inputs user utterance through a speech input unit and transmits the user utterance to the data processing server,

the data processing server

analyzes intention of the user utterance received from the user terminal and transmits a result obtained by the analysis to the user terminal,

the user terminal

executes processing of outputting system utterance corresponding to the intention of the user utterance through the speech output unit, and

the output control unit of the user terminal

executes volume control of the system utterance on the basis of a combination of a user distance and a user utterance volume,

the user distance being a distance from the user terminal to a user, and the user utterance volume being calculated on the basis of user utterance input through the speech input unit.

Further, according to a fifth aspect of the present disclosure,

there is provided a program causing an information processing apparatus to execute information processing, the apparatus including:

an output control unit configured to execute volume control of system utterance,

in which the program causes the output control unit

to execute volume control of the system utterance on the basis of a combination of a user distance and a user utterance volume,

the user distance being a distance from the information processing apparatus to a user, and the user utterance volume being calculated on the basis of user utterance input by the information processing apparatus.

Note that the program of the present disclosure is, in one example, a program accessible as a storage medium or a communication medium provided in a non-transitory computer-readable form to an information processing apparatus or a computer system capable of executing various program codes. Such a program provided in the non-transitory computer-readable form makes it possible for the processing in accordance with the program to be implemented on the information processing apparatus or the computer system.

Still other objects, features, and advantages of the present disclosure will become apparent from a detailed description based on embodiments of the present disclosure as described later and accompanying drawings. Note that the term “system” herein refers to a logical component set of a plurality of apparatuses and is not limited to a system in which apparatuses of the respective components are provided in the same housing.

### Effects of the Invention

The configuration of an embodiment according to the present disclosure allows the apparatus and method to be achieved, capable of controlling the volume of system utterance on the basis of a user distance, user utterance volume, ambient volume, and the like and outputting the system utterance at optimum volume.

Specifically, in one example, the output control unit controls the system utterance volume on the basis of a combination of the user distance that is a distance from the information processing apparatus to the user and the user utterance volume that is volume calculated on the basis of the user utterance input by the information processing apparatus. The system utterance volume is increased in the case where the user utterance volume is higher than the ordinary volume corresponding to the user distance, and the system utterance volume is decreased in the case where the user utterance volume is lower than the ordinary volume. In addition, control is performed to make the system utterance volume higher than the volume level of the ambient sound.

The present configuration achieves the apparatus and method capable of outputting the system utterance at the optimum volume by controlling the system utterance volume on the basis of the user distance, the user utterance volume, the ambient volume, and the like.

Note that the effects described in the present specification are merely examples and are not limited, and there may be additional effects.

### BRIEF DESCRIPTION OF DRAWINGS

FIG. 1 is a diagram illustrated to describe a specific processing example of an information processing apparatus that performs a response to user utterance.

FIG. 2 is a diagram illustrated to describe a configuration example and a usage example of the information processing apparatus.

FIG. 3 is a diagram illustrated to describe a configuration example of the information processing apparatus.

FIG. 4 is a diagram illustrated to describe an overview of processing executed by the information processing apparatus according to the present disclosure.

FIG. 5 is a diagram illustrated to describe an example of a correspondence relationship between a user distance and system utterance volume.

FIG. 6 is a diagram illustrated to describe an example of a correspondence relationship between ambient sound and system utterance volume.

FIG. 7 is a diagram illustrated to describe an example of a correspondence relationship between a user request and system utterance volume.

FIG. 8 is a diagram illustrated to describe an example of a correspondence relationship between a user request and system utterance volume.

FIG. 9 is a diagram illustrated to describe an example of a correspondence relationship among ambient sound, system utterance volume, and system music volume.

FIG. 10 is a diagram illustrated to describe an example of a correspondence relationship among ambient sound, system utterance volume, system music volume, and system BGM volume.

FIG. 11 is a diagram illustrated to describe an example of control for each time zone of system utterance volume.

FIG. 12 is a diagram illustrated to describe an example of processing of displaying system utterance contents on a display unit.

FIG. 13 is a diagram illustrated to describe an example of settings of the control extent of system utterance volume.

FIG. 14 is a diagram illustrated to describe an example of controlling system utterance volume using context information (context).

FIG. 15 is a diagram illustrated to describe an example of controlling system utterance volume using context information (context).

FIG. 16 is a flowchart illustrated to describe a control sequence of a system output such as system utterance.

FIG. 17 is a flowchart illustrated to describe a control sequence of a system output such as system utterance.

FIG. 18 is a flowchart illustrated to describe a control sequence of a system output such as system utterance.

FIG. 19 is a diagram illustrated to describe a configuration example of an information processing system.

FIG. 20 is a diagram illustrated to describe an example of a hardware configuration of the information processing apparatus.

### MODE FOR CARRYING OUT THE INVENTION

Details of each of an information processing apparatus, an information processing system, and an information processing method, and a program according to the present disclosure are now described with reference to the drawings. Moreover, a description is made according to the following items.

1. Regarding overview of processing executed by information processing apparatus

2. Regarding configuration example of information processing apparatus

3. Regarding example of specific output control processing executed by output (speech or image) control unit

3-1. (Control Example 1) Control example corresponding to distance between information processing apparatus and user

3-2. (Control Example 2) Control example corresponding to ambient sound

3-3. (Control Example 3) Control example in response to user request

3-4. (Control Example 4) Control example considering system output sound (such as music) other than system utterance

3-5. (Control Example 5) Control example considering time zone

3-6. (Control Example 6) Control example of displaying system utterance contents on display unit

3-7. (Control Example 7) Setting example for each control

3-8. (Control Example 8) Other control examples

4. Processing sequence executed by information processing apparatus

4-1. (Processing Example 1) Volume control processing based on user distance, user utterance volume, ambient volume, or the like

4-2. (Processing Example 2) Volume control processing based on user distance, user utterance volume, ambient volume, user request, or the like

4-3. (Processing Example 3) Volume control processing based on user distance, user utterance volume, ambient volume, context information (context), or the like

5. Regarding configuration examples of information processing apparatus and information processing system

6. Regarding hardware configuration example of information processing apparatus

7. Summary of configuration of present disclosure

[1. Overview of Processing Executed by Information Processing Apparatus]

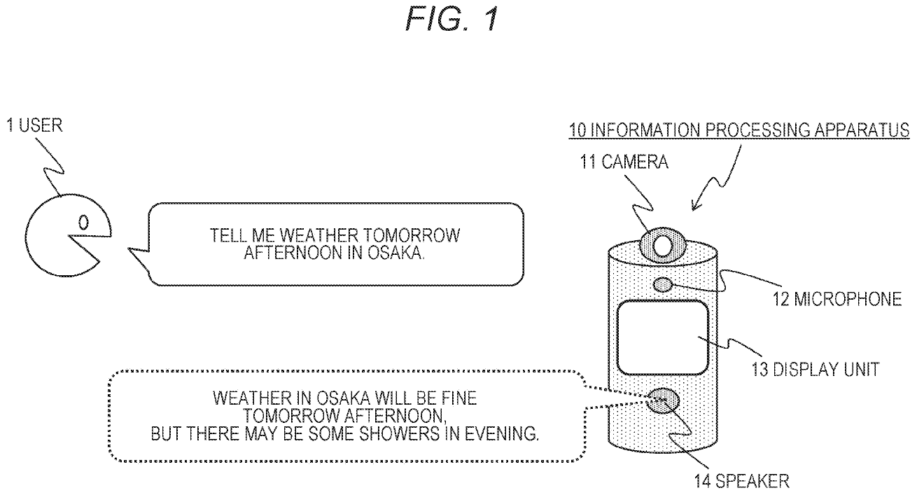

An overview of processing executed by an information processing apparatus of the present disclosure is now described with reference to FIG. 1 and the following drawings.

FIG. 1 is a diagram illustrating an example of processing performed in an information processing apparatus 10 to recognize user utterance spoken by a user 1 and make a response.

The information processing apparatus 10 executes speech recognition processing on the user utterance of, for example,

“Tell me the weather tomorrow afternoon in Osaka”.

Moreover, the information processing apparatus 10 executes processing based on a result obtained by speech recognition of the user utterance.

In the example illustrated in FIG. 1, it acquires data used to a response to the user utterance of “tell me the weather tomorrow afternoon in Osaka”, generates a response on the basis of the acquired data, and outputs the generated response through a speaker 14.

In the example illustrated in FIG. 1, the information processing apparatus 10 makes a system response as below.

The system response is “The weather in Osaka will be fine tomorrow afternoon, but there may be some showers in the evening”.

The information processing apparatus 10 executes speech synthesis processing (text to speech: TTS) to generate the system response mentioned above and output it.

The information processing apparatus 10 generates and outputs the response using knowledge data acquired from a storage unit in the apparatus or knowledge data acquired via a network.

The information processing apparatus 10 illustrated in FIG. 1 includes a camera 11, a microphone 12, a display unit 13, and the speaker 14, and has a configuration capable of inputting or outputting speech and image.

The information processing apparatus 10 illustrated in FIG. 1 is referred to as, for example, a smart speaker, or an agent device.

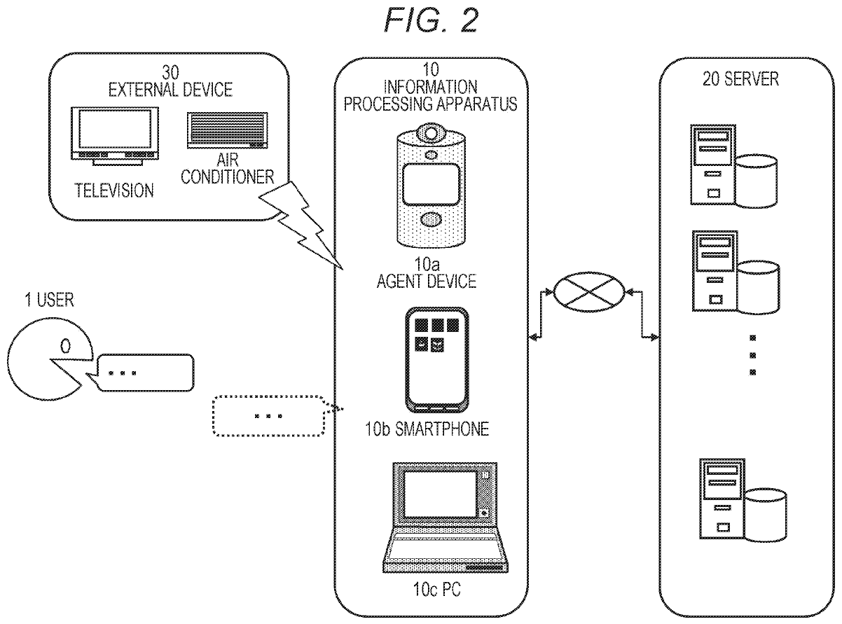

As illustrated in FIG. 2, the information processing apparatus 10 according to the present disclosure is not limited to an agent device 10a and can be implemented as various apparatus forms such as a smartphone 10b and a PC 10c.

The information processing apparatus 10 recognizes the utterance of the user 1 and not only performs the response based on the user utterance but also, for example, executes control of an external device 30 such as a television and an air conditioner illustrated in FIG. 2 in accordance with the user utterance.

For example, there is a case where the user utterance is a request such as “Change the television channel to channel 1” and “Set the temperature of the air conditioner to 20 degrees”. In this case, the information processing apparatus 10 outputs a control signal (Wi-Fi, infrared light, etc.) to the external device 30 on the basis of a speech recognition result of the user utterance to cause the external device 30 to execute control in accordance with the user utterance.

Moreover, the information processing apparatus 10, when connecting to a server 20 via a network, is capable of acquiring information necessary to generate a response to the user utterance from the server 20. In addition, it is also possible to cause the server to execute the speech recognition processing or the semantic analysis processing.

[2. Regarding Configuration Example of Information Processing Apparatus]

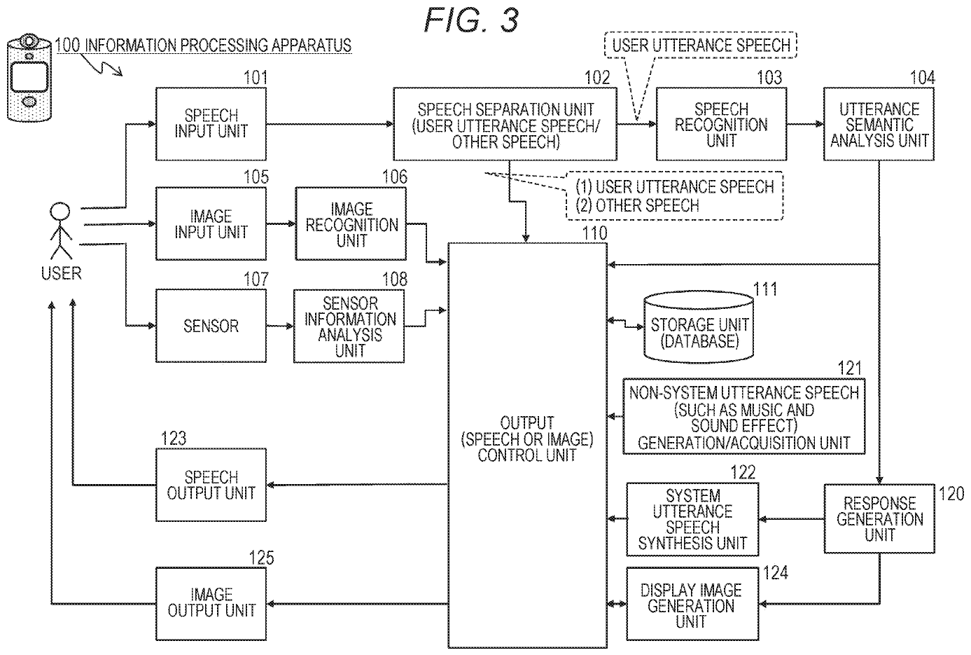

Next, with reference to FIG. 3, a specific configuration example of the information processing apparatus will be described.

FIG. 3 is a diagram illustrating an example of a configuration of an information processing apparatus 100 to recognize user utterance and make a response.

As illustrated in FIG. 3, the information processing apparatus 100 includes a speech input unit 101, a speech separation unit 102, a speech recognition unit 103, an utterance semantic analysis unit 104, an image input unit 105, an image recognition unit 106, a sensor 107, a sensor information analysis unit 108, an output (speech or image) control unit 110, a storage unit (database) 111, a response generation unit 120, a non-system utterance speech (such as music and sound effect) generation/acquisition unit 121, a system utterance speech synthesis unit 122, a speech output unit 123, a display image generation unit 124, and an image output unit 125.

Note that all of these components can be also configured in the single information processing apparatus 100, but may be configured such that some components or functions are provided in another information processing apparatus or an external server.

The user utterance speech and ambient sound are input to the speech input unit 101 such as a microphone.

The speech input unit (microphone) 101 inputs, to the speech separation unit 102, speech data including the user utterance speech that is input.

The speech separation unit 102 separates, from the input speech data, the user utterance speech and other ambient sounds, for example, other sounds including music and noise such as air conditioner sound.

The speech separation unit 102 has, in one example, a voice activity detection (VAD) function. VAD is a technique that enables the user utterance speech and environmental noise to be distinguished from an input sound signal to specify a period during which the user's speech is uttered.

The user utterance speech separated by the speech separation unit 102 is input to the speech recognition unit 103. Furthermore, the user utterance speech separated by the speech separation unit 102 and other speech also are input to the output (speech or image) control unit 110.

The speech recognition unit 103 has, for example, an automatic speech recognition (ASR) function, and converts speech data into text data constituted by a plurality of words.

The text data generated by the speech recognition unit 103 is input to the utterance semantic analysis unit 104.

The utterance semantic analysis unit 104 selects and outputs intent candidate of a user included in the text.

The utterance semantic analysis unit 104 has, for example, a natural language understanding function such as natural language understanding (NLU), and estimates an intention (intent) of the user utterance and entity information (entity) which is a meaningful element (significant element) included in the utterance from the text data.

Specific examples are described. In one example, assume that the user utterance mentioned below is input.

The intention (intent) of the user utterance of “Tell me the weather tomorrow afternoon in Osaka”

is to know the weather, and

the entity information (entity) is Osaka, tomorrow, afternoon, and words of these.

If an intention (entity) and entity information (entity) can be accurately estimated and acquired from a user utterance, the information processing apparatus 100 can perform accurate processing on the user utterance.

For example, it is possible to acquire the weather for tomorrow afternoon in Osaka and output the acquired weather as a response in the above example.

Moreover, the intention estimation processing of the user utterance in the utterance semantic analysis unit 104 is performed after the completion of user utterance, so the intention of the user utterance during the period in which the user utters, that is, the period during the execution of the detection of user utterance fails to be acquired. In a case where the user utterance is completed and the intention of the user utterance is estimated by the utterance semantic analysis unit 104, that is, the estimation of the intention (intent) and the entity information (entity) for the user utterance is completed, the estimation result is input to the response generation unit 120.

The response generation unit 120 generates a response to the user on the basis of the intention (intent) of the user utterance estimated by the utterance semantic analysis unit 104 and the entity information (entity). The response includes at least one of speech or image.

In a case of outputting the response speech, the speech information generated by executing the speech synthesis processing (text-to-speech: TTS) in the system utterance speech synthesis unit 122 is output through the speech output unit 123 such as a speaker.

In a case of outputting the response image, the display image information generated by the display image synthesis unit 124 is output through the image output unit 125 such as a display.

Moreover, the output (speech or image) control unit 110 controls any sound, image, and output thereof.

Specifically, the control of output volume, the control of whether or not to execute an image output, and the like are performed.

A specific control example will be described later.

The image output unit 125 includes, in one example, a display such as an LCD and an organic EL display, a projector that performs projection display, or the like.

Moreover, the information processing apparatus 100 is capable of outputting and displaying an image on an external connection device, for example, a television, a smartphone, a PC, a tablet, an argumented reality (AR) device, a virtual reality (VR) device, and other home appliances.

The non-system utterance speech (such as music and sound effect) generation/acquisition unit 121 generates and acquires a sound other than the system utterance, such as music, alarm sound, and sound effect.

Examples of the music include music stored in a storage unit of an information processing apparatus (not shown) or music or the like obtained from a music-providing server connected via a network.

Moreover, there are two types of music, that is, music (ordinary music) played back by a playback request of the user for listening to music, for example, and BGM music played back in the background. The output volume of BGM is set to be lower than that of the played music (ordinary music).

Moreover, there is also BGM that is played back by the user's request.

Examples of the alarm sound and the sound effect include an alarm output at the set time of the user, a sound effect output upon receiving an email or the like, and the like.

The music and sound effect generated or acquired by the non-system utterance speech (such as music and sound effect) generation/acquisition unit 121 are output, as speech information generated by the speech synthesis processing (text-to-speech: TTS) in the system utterance speech synthesis unit 122, through the speech output unit 123 such as a speaker.

Moreover, the output of the music and sound effect generated or acquired by the non-system utterance speech (such as music and sound effect) generation/acquisition unit 121 is also controlled by the output (speech or image) control unit 110. Specifically, the output volume is controlled.

A specific control example will be described later.

As described above, the output (speech or image) control unit 110 controls the output of each data item mentioned as follows:

(A) System utterance speech generated by the speech synthesis processing (text-to-speech: TTS) in the system utterance speech synthesis unit 122

(B) Display information corresponding to the system utterance generated in the display image synthesis unit 124

(C) Music or sound effect generated or acquired by the non-system utterance speech (such as music and sound effect) generation/acquisition unit 121

The output of each of these data items is controlled using the information mentioned as follows:

(1) User speech and other sound information detected by the speech separation unit 102 on the basis of the user utterance

(2) Intention (intent) and entity information (entity) of the user utterance generated by executing natural-language understanding (NLU) on text data in the utterance semantic analysis unit 104

(3) Result information of image recognition by the image recognition unit 106 on images of the uttering user and the surroundings acquired by the image input unit 105 such as a camera

(4) Sensor analysis information analyzed by the sensor information analysis unit 108 on the basis of the detected information of the uttering and the surrounding state acquired by the sensor 107

(5) User information and data for system utterance control (reference value) acquired from the storage unit (database) 111

As described above, the output (speech or image) control unit 110 controls, on the basis of the input information of (1) to (5) described above, the output of each data of (A), (B), and (C) mentioned as follows:

(A) System utterance speech generated by the speech synthesis processing (text-to-speech: TTS) in the system utterance speech synthesis unit 122

(B) Display information corresponding to the system utterance generated in the display image synthesis unit 124

(C) Music or sound effect generated or acquired by the non-system utterance speech (such as music and sound effect) generation/acquisition unit 121

Moreover, the storage unit (database) 111 records the data used to control the system utterance (reference value).

Furthermore, information used to identify the user from the user's face image is also recorded.

Specifically, a user ID associated with the facial feature information of each registered user is recorded.

Moreover, the data used to control system utterance (reference value) recorded in the storage unit (database) 111 includes two types of data,

that is, general data that does not identify the user (general reference value for system utterance control) and

user-specific data associated with the specified user (user-specific reference value for system utterance control).

The output (speech or image) control unit 110 executes, in one example, a search of the storage unit (database) 111 based on the face image of the user input from the image input unit 105 to identify who the uttering user is (user ID). Furthermore, an output control reference value of the specified user is acquired to control the output (speech and image) depending on the acquired output control reference value corresponding to the uttering user.

The control performed in the output (speech or image) control unit 110 includes volume control of system utterance, music, and sound effect, display control of contents of system utterance on the image output unit 125, and the like.

[3. Regarding Example of Specific Output Control Processing Executed by Output (Speech or Image) Control Unit]

Next, an example of specific output control processing executed by output (speech or image) control unit 110 will be described.

As described above, the output (speech or image) control unit 110 executes the volume control of system utterance, music, and sound effect and executes the display control of the system utterance contents on the image output unit 125.

The control executed by the output (speech or image) control unit 110 is now described in the order of the list as follows:

(Control Example 1) Control example corresponding to distance between information processing apparatus and user

(Control Example 2) Control example corresponding to ambient sound

(Control Example 3) Control example in response to user request

(Control Example 4) Control example considering system output sound (such as music) other than system utterance

(Control Example 5) Control example considering time zone

(Control Example 6) Control example of displaying system utterance contents on the display unit

(Control Example 7) Setting example for each control

(Control Example 8) Other control examples

Moreover, Control Examples 1 to 8 are now described individually for the convenience of understanding the processing, but the information processing apparatus 100 according to the present disclosure is capable of executing Control Examples 1 to 8 individually or in any combination.

[3-1. (Control Example 1) Control Example Corresponding to Distance Between Information Processing Apparatus and User]

First, as (Control Example 1), a control example corresponding to distance between information processing apparatus and user will be described.

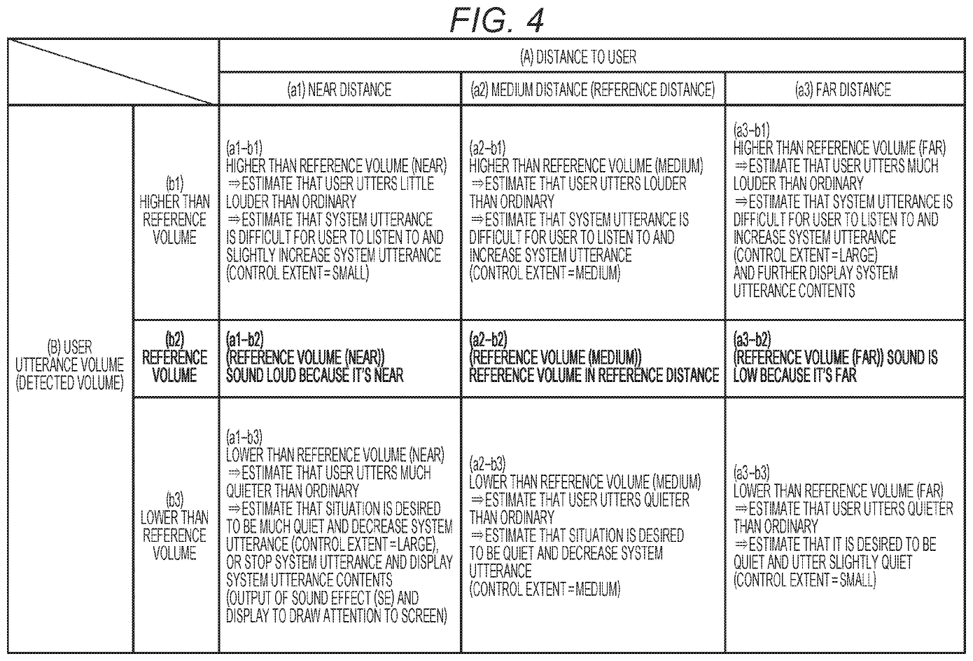

FIG. 4 is a diagram illustrated to describe a control mode executed by the output (speech or image) control unit 110 of the information processing apparatus 100 according to the present disclosure depending on a distance between the information processing apparatus and a user.

In the figure, “(A) Distance to user” (distance between the information processing apparatus and the user) is shown in the horizontal column, and

“(B) User utterance volume” (detected volume of the information processing apparatus) is shown in the vertical column.

“(A) Distance to user” (the distance between the information processing apparatus and the user)

is classified into three types of

(a1) Near distance,

(a2) Medium distance (reference distance), and

(a3) Far distance.

“(B) User utterance volume” (detected volume of the information processing apparatus) is classified into three types of

(b1) Higher than reference volume,

(b2) Reference volume, and

(b3) Lower than reference volume.

Moreover, the reference volume is data stored in the storage unit of the information processing apparatus 100 and is volume information input to the speech input unit 101 of the information processing apparatus 100 on the basis of normal user utterance corresponding to the user distance.

The detected volume of the user utterance varies depending on the user distance.

The detected volume of normal user utterance in a case where the user distance is the medium distance (reference distance) is set as the reference volume.

In FIG. 4, however, the detected volume of the normal user utterance in a case where the user distance is the medium distance (reference distance) is shown as reference volume (medium).

Furthermore, the detected volume of the normal user utterance in a case where the user distance is the near distance is shown as the reference volume (near). The detected volume of the normal user utterance in a case where the user distance is the far distance is shown as the reference volume (far).

The detected volume of user utterance increases as the user distance decreases and decreases as the user distance increases. Thus, the magnitude relationship among the reference volume (medium), the reference volume (near), and the reference volume (far) is as follows.

Reference Volume (near)>Reference Volume (medium)>Reference Volume (far)

The output (speech or image) control unit 110 of the information processing apparatus 100 calculates:

(A) User distance from the user image input to the image input unit 101 of the information processing apparatus 100, and

(B) User utterance volume from the user utterance input to the speech input unit 101 of the information processing apparatus 100.

Furthermore, depending on which the combination of the calculated (A) User distance and (B) User utterance volume corresponds to which of nine divided parts illustrated in FIG. 4, that is, (a1-b1) to (a3-b3), the output mode of the system utterance is changed depending on the setting described in each part.

Moreover, in a case where the (B) User utterance volume is the reference volume (reference volume (near), reference volume (medium), or reference volume (far)) depending on the user distance, the output depending on a preset normal control mode is controlled.

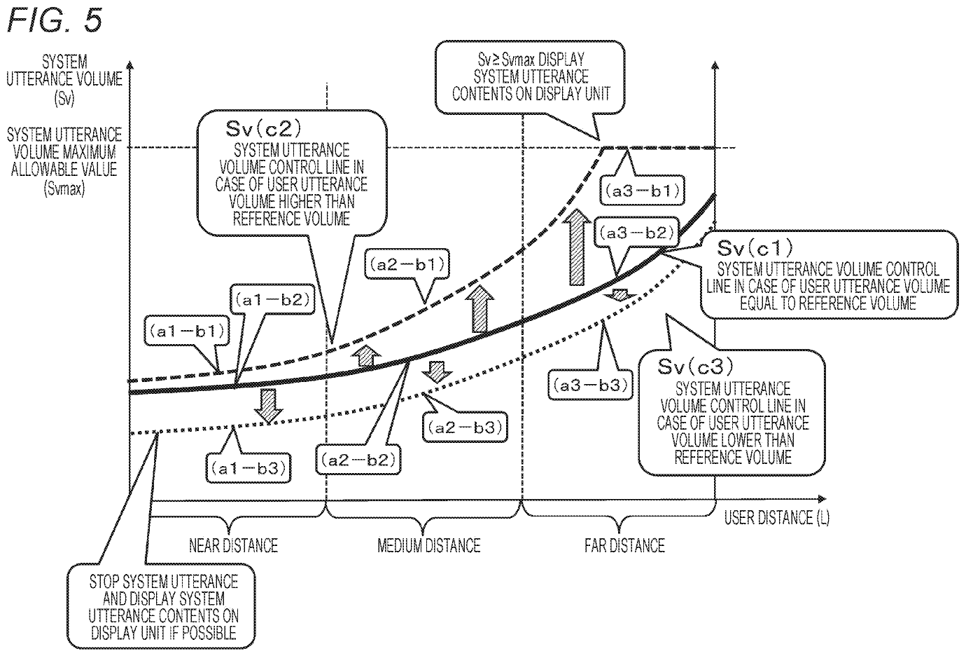

An example of this normal control mode is described with reference to FIG. 5.

The graph shown in FIG. 5 is a graph in which the horizontal axis represents user distance (L) and the vertical axis represents system utterance volume (Sv).

FIG. 5 shows three control lines.

The central solid line (Sv (c1)) is a normal system utterance volume control line.

In other words, this control line indicates the volume control mode of the normal system utterance executed in the case where the user utterance volume is the reference volume (reference volume (near), reference volume (medium), or reference volume (far)) depending on the user distance.

The normal system utterance volume control line (Sv (c1)) is set in such a way that the system utterance volume increases as the user distance increases.

Such control makes it easier to listen to the system utterance even if the user is away from the information processing apparatus 100.

In FIG. 5, in addition to the normal system utterance volume control line (Sv (c1)),

two control lines are shown on the upper and lower sides to sandwich this line.

The upper control line (Sv (c2)) is

the system utterance volume control line (Sv (c2)) in a case where the user utterance volume is higher than the reference volume.

On the other hand, the lower control line (Sv (c3)) is

the system utterance volume control line (Sv (c3)) in a case where the user utterance volume is lower than the reference volume.

The parts describing the control processing corresponding to the system utterance volume control line (Sv (c2)) in the case where the user utterance volume is higher than the reference volume are parts (a1-b1), (a2-b1), and (a3-b1) shown in the table of FIG. 4.

On the other hand, the parts describing the control processing corresponding to the system utterance volume control line (Sv (c3)) in the case where the user utterance volume is lower than the reference volume are parts (a1-b3), (a2-b3), and (a3-b3) shown in the table of FIG. 4.

Moreover, the control processing corresponding to the parts (a1-b2), (a2-b2), and (a3-b2) shown in the table of FIG. 4 is performed depending on the normal system utterance volume control line (Sv (c1)) shown in FIG. 5.

The normal system utterance volume control line (Sv (c1)) is recorded previously in the storage unit of the information processing apparatus 100, and the output (speech or image) control unit 110 of the information processing apparatus 100

executes the volume control of the system utterance speech in accordance with the normal system utterance volume control line (Sv (c1)), in a case where it is detected that the combination of

the (A) User distance calculated from the user image input to the image input unit 101 of the information processing apparatus 100 and

the (B) User utterance volume calculated from the user utterance input to the speech input unit 101 of the information processing apparatus 100 corresponds to the parts (a1-b2), (a2-b2), and (a3-b2) shown in FIG. 4.

In the case where (A) User distance and (B) User utterance volume correspond to the parts (a1-b1), (a2-b1), and (a3-b1) shown in the table of FIG. 4, the output control of the system utterance is executed in accordance with the system utterance volume control line (Sv (c2)) in the case where the user utterance volume is higher than the reference volume as shown in FIG. 5.

A specific processing mode, in this case, is described with reference to the description of the parts (a1-b1), (a2-b1), and (a3-b1) shown in the table of FIG. 4.

(Control Processing Corresponding to Part (a1-b1))

The part (a1-b1) indicates

the control processing in the case where

(A) User distance is near distance and

(B) User utterance volume is higher than the reference volume (near).

In this case, the output (speech or image) control unit 110 of the information processing apparatus 100 executes the processing as follows.

The processing of estimating that the user utters slightly louder than ordinary is executed

on the basis of the fact that the user utterance volume is detected as a volume higher than the reference volume (near). Depending on the estimation,

the processing of estimating that the system utterance is in a situation where the user is difficult to listen to and executing the control for slightly increasing the system utterance (control extent=small) is executed.

(Control Processing Corresponding to Part (a2-b1))

The part (a2-b1) indicates

the control processing in the case where

(A) User distance is medium distance and

(B) User utterance volume is higher than the reference volume (medium).

In this case, the output (speech or image) control unit 110 of the information processing apparatus 100 executes the processing as follows.

The processing of estimating that the user utters louder than ordinary is executed

on the basis of the fact that the user utterance volume is detected as a volume higher than the reference volume (medium). Depending on the estimation,

the processing of estimating that the system utterance is in a situation where the user is difficult to listen to and executing the control for increasing the system utterance (control extent=medium) is executed.

(Control Processing Corresponding to Part (a3-b1))

The part (a3-b1) indicates

the control processing in the case where

(A) User distance is far distance and

(B) User utterance volume is higher than the reference volume (near).

In this case, the output (speech or image) control unit 110 of the information processing apparatus 100 executes the processing as follows.

The processing of estimating that the user utters much louder than ordinary is executed

on the basis of the fact that the user utterance volume is detected as a volume that is higher than the reference volume (far). Depending on the estimation,

the processing of estimating that the system utterance is in a situation where the user is difficult to listen to and executing the control to increase the system utterance (control extent=large) is executed.

Furthermore, the processing of displaying the system utterance contents is executed depending on the contexts. In one example, as illustrated in FIG. 5, in the case where the system utterance volume reaches a predetermined maximum allowable value (Svmax), the processing of displaying the system utterance contents on the image output unit 125 is executed.

Meanwhile, in the case where (A) User distance and (B) User utterance volume correspond to the parts (a1-b3), (a2-b3), and (a3-b3) shown in the table of FIG. 4, the output control of the system utterance is executed in accordance with the system utterance volume control line (Sv (c3)) in the case where the user utterance volume is lower than the reference volume as shown in FIG. 5.

A specific processing mode, in this case, is described with reference to the description of the parts (a1-b3), (a2-b3), and (a3-b3) shown in the table of FIG. 4.

(Control Processing Corresponding to Part (a1-b3))

The part (a1-b3) indicates

the control processing in the case where

(A) User distance is near distance and

(B) User utterance volume is lower than the reference volume (near).

In this case, the output (speech or image) control unit 110 of the information processing apparatus 100 executes the processing as follows.

The processing of estimating that the user utters much lower than ordinary is executed

on the basis of the fact that the user utterance volume is detected as a volume lower than the reference volume (near). Depending on the estimation,

the processing of estimating that the user desires to be much quiet and executing the control to decrease the system utterance (control extent=large) is executed.

Furthermore, the processing of stopping the system utterance depending on the contexts and displaying the system utterance contents on the image output unit 125 is executed. In one example, in a case where the system utterance volume is too low and reaches a level at which it is hardly listened, the display processing is performed on the display unit.

(Control Processing Corresponding to Part (a2-b3))

The part (a2-b3) indicates

the control processing in the case where

(A) User distance is medium distance and

(B) User utterance volume is lower than the reference volume (medium).

In this case, the output (speech or image) control unit 110 of the information processing apparatus 100 executes the processing as follows.

The processing of estimating that the user utters lower than ordinary is executed

on the basis of the fact that the user utterance volume is detected as a volume lower than the reference volume (medium). Depending on the estimation,

the processing of estimating that the user desires to be quiet and executing the control to reduce the system utterance (control extent=medium) is executed.

(Control Processing Corresponding to Part (a3-b3))

The part (a3-b3) indicates

the control processing in the case where

(A) User distance is far distance and

(B) User utterance volume is lower than the reference volume (near).

In this case, the output (speech or image) control unit 110 of the information processing apparatus 100 executes the processing as follows.

The processing of estimating that the user utters lower than ordinary is executed

on the basis of the fact that the user utterance volume is detected as a volume lower than the reference volume (far). Depending on the estimation,

the processing of estimating that the user desires to be quiet and executing the control to reduce the system utterance (control extent=small) is executed.

As described above with reference to FIGS. 4 and 5, the output (speech or image) control unit 110 of the information processing apparatus 100 controls the output of the system utterance speech or the output image depending on the user distance and the volume of user utterance speech.

In other words, the output (speech or image) control unit 110 executes the following processing.

(A) User distance from the user image input to the image input unit 101 of the information processing apparatus 100 is calculated.

(B) User utterance volume from the user utterance input to the speech input unit 101 of the information processing apparatus 100.

Furthermore, depending on which the combination of the calculated (A) User distance and (B) User utterance volume corresponds to which of nine divided parts illustrated in FIG. 4, that is, (a1-b1) to (a3-b3), the output mode of the system utterance is changed depending on the setting described in each part.

[3-2. (Control Example 2) Control Example Corresponding to Ambient Sound]

A control example corresponding to ambient sound as (Control Example 2) is now described.

Not only the user utterance speech but also various ambient sounds are input to the speech input unit (microphone) 101 of the information processing apparatus 100 described with reference to FIG. 3.

As described with reference to FIG. 3 above, the speech input unit (microphone) 101 inputs, to the speech separation unit 102, speech data including the user utterance speech that is input.

The speech separation unit 102 separates, from the input speech data, the user utterance speech and other ambient sounds, for example, other sounds including music and noise such as air conditioner sound.

The speech separation unit 102 has, in one example, a voice activity detection (VAD) function. VAD is a technique that enables the user utterance speech and environmental noise to be distinguished from an input sound signal to specify a period during which the user's speech is uttered.

The user utterance speech and the ambient sound separated by the speech separation unit 102 are input to the output (speech or image) control unit 110.

The output (speech or image) control unit 110 calculates user utterance volume and ambient sound volume and executes volume control of a system utterance speech or the like depending on the calculated volume.

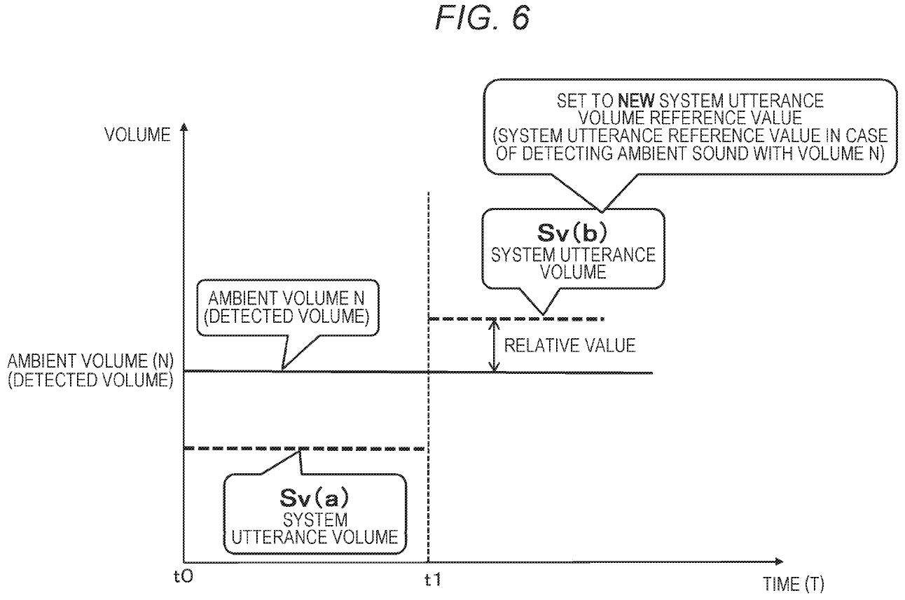

A processing example of the volume control of the system utterance speech depending on the ambient sound volume that is executed by the output (speech or image) control unit 110 is described with reference to FIG. 6.

The graph shown in FIG. 6 is a graph in which time (T) is set on the horizontal axis and volume is set on the vertical axis.

In one example, the information processing apparatus 100 starts system utterance from time t0. The volume of the system utterance is executed on the basis of, in one example, the volume decided by the user distance and the user utterance volume described above with reference to FIGS. 4 and 5.

This system utterance volume of the system utterance is set as Sv (a).

Here, it is assumed that ambient sound of a fixed volume (N) is detected from the input of the speech input unit (microphone) 101 during the execution of the system utterance.

It is assumed that an ambient volume N illustrated in FIG. 6 is detected.

In this case, the output (speech or image) control unit 110 of the information processing apparatus 100 performs control to change the system utterance speech volume to a volume higher than the ambient volume N.

As illustrated in FIG. 6, at and after time t1, the control is performed to set the system utterance volume of the system utterance to Sv (b).

The system utterance volume Sv (b) is higher than the ambient volume N of the ambient sound.

Moreover, it is preferable that the difference (relative value) between the system utterance volume Sv (b) and the ambient volume N of the ambient sound be kept constant.

In other words, if the ambient volume N increases, the system utterance volume Sv (b) also increases, and if the ambient volume N decreases, the system utterance volume Sv (b) also decreases.

This control makes it possible for the user to listen to the system utterance with volume louder than the ambient sound and to eliminate the difficulty of listening to the system utterance.

However, the maximum allowable value and minimum allowable value of the system utterance volume Sv (b) are predefined, and in a case where the system utterance volume Sv (b) reaches the maximum allowable value or minimum allowable value, the processing of displaying the system utterance contents on the display unit is performed.

This processing is similar to the processing described above with reference to FIGS. 4 and 5.

Moreover, the system utterance volume Sv (b) after the detection of the ambient sound of the ambient volume N is recorded in the storage unit (database) 111 as a system utterance volume reference value upon detecting the ambient sound of the ambient volume N.

After the reference value is recorded in the storage unit (database) 111, the control of the system utterance volume is performed in such a way as to match the system utterance volume reference value (=Sv (b)) upon detecting the ambient sound of the ambient volume N.

[3-3. (Control Example 3) Control Example in Response to User Request]

A control example in response to a user request as (Control Example 3) is now described.

The preferred volume of the system utterance varies depending on the individual user.

The control example described below is a control example in which an optimal system utterance volume depending on each user's preference can be set.

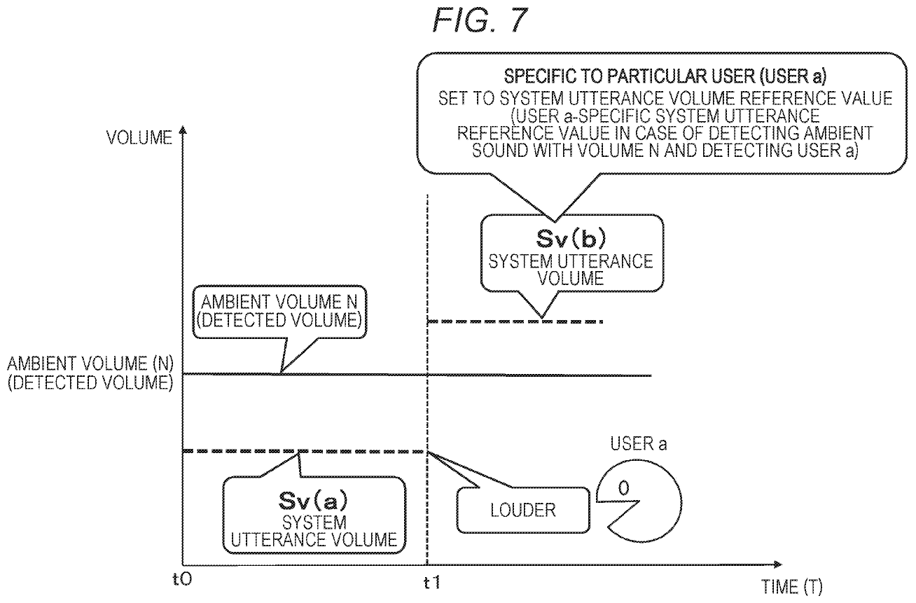

A processing example of the volume control of the system utterance speech depending on the user request that is executed by the output (speech or image) control unit 110 is described with reference to FIG. 7.

The graph shown in FIG. 7 is, similar to the FIG. 6 described above, a graph in which time (T) is set on the horizontal axis and volume is set on the vertical axis.

In one example, the information processing apparatus 100 starts system utterance from time t0. The volume of the system utterance is executed on the basis of, in one example, the volume decided by the user distance and the user utterance volume described above with reference to FIGS. 4 and 5.

This system utterance volume of the system utterance is set as Sv (a).

Moreover, it is assumed that ambient sound with fixed volume (N) is detected from the input of the speech input unit (microphone) 101 during the execution of the system utterance. This is the ambient sound with the ambient volume N shown in FIG. 7.

In (Control Example 2) described above with reference to FIG. 6, the control of the system utterance sound is performed depending on detection of the ambient sound. However, in the example illustrated in FIG. 7, the volume control of the system utterance is performed on the basis of a user request.

A user a makes the user utterance at time t1 as follows.

User utterance=Louder

This user utterance is input from the speech input unit (microphone) 101 to the speech recognition unit 103 and the utterance semantic analysis unit 104, and is analyzed that the user desires to increase the volume of the system utterance. This analysis result is input to the output (speech or image) control unit 110.

The output (speech or image) control unit 110 performs control to change the system utterance speech volume to volume higher than the ambient volume N in response to the user request.

As illustrated in FIG. 7, at and after time t1, the control is performed to set the system utterance volume of the system utterance to Sv (b).

The system utterance volume Sv (b) is higher than the ambient volume N of the ambient sound.

This control makes it possible for the user to listen to the system utterance with volume louder than the ambient sound and to eliminate the difficulty of listening to the system utterance.

Moreover, the system utterance volume Sv (b) after the user request is recorded in the storage unit (database) 111 as a system utterance volume reference value corresponding to user a upon detecting the ambient sound of the ambient volume N.

After the reference value is recorded in the storage unit (database) 111, the control of the system utterance volume is performed in such a way as to match the system utterance volume reference value (=Sv (b)) in a case where user a is detected and the ambient sound of the ambient volume N is detected.

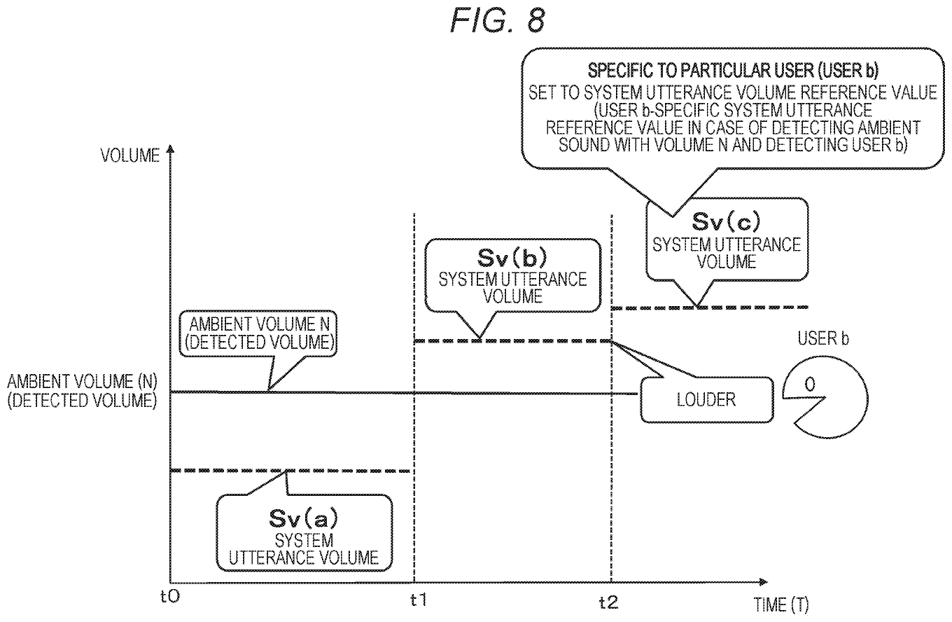

Further, another processing example of the volume control of the system utterance speech depending on the user request that is executed by the output (speech or image) control unit 110 is described with reference to FIG. 8.

The graph shown in FIG. 8 is, similar to FIG. 7, a graph in which time (T) is set on the horizontal axis and volume is set on the vertical axis.

In one example, the information processing apparatus 100 starts system utterance from time t0. The volume of the system utterance is executed on the basis of, in one example, the volume decided by the user distance and the user utterance volume described above with reference to FIGS. 4 and 5.

This system utterance volume of the system utterance is set as Sv (a).

Moreover, it is assumed that ambient sound with fixed volume (N) is detected from the input of the speech input unit (microphone) 101 during the execution of the system utterance. This is the ambient sound having the ambient volume N shown in FIG. 8.

In the processing example of FIG. 8, similarly to the processing (Control Example 2) described above with reference to FIG. 6, at time t1 in which the control of the system utterance sound is performed depending on the detection of the ambient sound, the control to set the system utterance volume to Sv (b) is performed.

In the example illustrated in FIG. 8, furthermore, at time t2, a user b makes the following user utterance.

User utterance=Louder

This user utterance is input from the speech input unit (microphone) 101 to the speech recognition unit 103 and the utterance semantic analysis unit 104, and is analyzed that the user desires to increase the volume of the system utterance. This analysis result is input to the output (speech or image) control unit 110.

The output (speech or image) control unit 110 performs control to change the system utterance speech volume to volume higher than the current system utterance volume Sv (b) in response to the user request.

As illustrated in FIG. 8, at and after time t2, the control is performed to set the system utterance volume of the system utterance to Sv (c).

The system utterance volume Sv (c) is higher than Sv (b).

This control makes it possible for the user b to listen to the system utterance with volume louder and to eliminate the difficulty of listening to the system utterance.

Moreover, the system utterance volume Sv (c) after the user request is recorded in the storage unit (database) 111 as a system utterance volume reference value corresponding to user b upon detecting the ambient sound of the ambient volume N.

After the reference value is recorded in the storage unit (database) 111, the control of the system utterance volume is performed in such a way as to match the system utterance volume reference value (=Sv (c)) in a case where user b is detected and the ambient sound of the ambient volume N is detected.

Moreover, the examples shown in FIGS. 7 and 8 are requests to increase the system utterance if the user request is “louder”, but conversely, if the user request is “quieter”, the request to decrease the system utterance is made in some cases. In this case, the output (speech or image) control unit 110 of the information processing apparatus 100 decreases the volume of the system utterance and stores the volume value (reference value) associated with a user identifier of the user in the storage unit (database) 111.

In addition, a case can occur in which the user request contradicts the control mode decided on the basis of the user distance and the user utterance volume described above with reference to FIG. 4, but in this case, the control is executed with priority given to the user request.

[3-4. (Control Example 4) Control Example Considering System Output Sound (Such as Music) Other than System Utterance]

Next, as (Control Example 4), a control example considering system output sound (such as music) other than system utterance will be described.

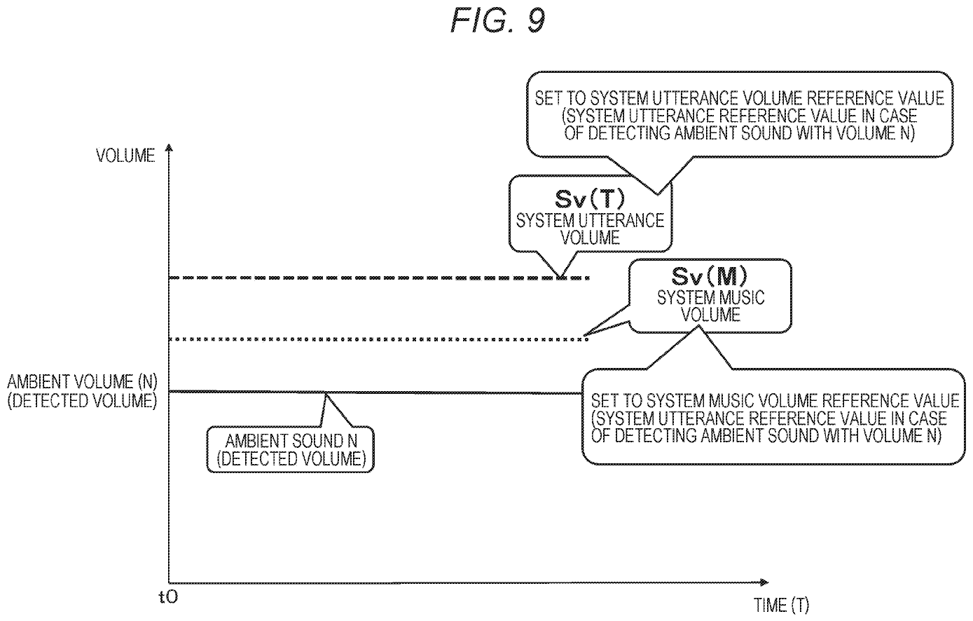

A control example considering system output sound (such as music) other than the system utterance executed by the output (speech or image) control unit 110 is described with reference to FIG. 9.

Moreover, the present example is a processing example in which the information processing apparatus 100 executes system utterance while playing back music.

The graph shown in FIG. 9 is a graph in which time (T) is set on the horizontal axis and volume is set on the vertical axis, which is similar to FIGS. 7 and 8.

It is assumed that ambient sound of fixed volume (N) is detected from the input of the speech input unit (microphone) 101. This is an ambient sound with the ambient volume N shown in FIG. 9.

As described above, in a case where the ambient sound of the ambient volume N is detected, the output (speech or image) control unit 110 of the information processing apparatus 100 executes the music playback set to volume higher than the ambient volume N of the ambient sound.

The music playback set to the system music volume (Sv (M)) shown in FIG. 9 is executed.

Furthermore, in a case of executing the system utterance during the music playback period, the output (speech or image) control unit 110 of the information processing apparatus 100 executes the system utterance by setting the system utterance volume to volume (Sv (T)) higher than the system music volume (Sv (M)).

This processing makes it possible for the user to listen to the system utterance at the volume (Sv (T)) higher than the ambient volume (N) or the system music volume (Sv (M)), resulting in eliminating the difficulty in listening to the system utterance.

Moreover, the system utterance volume Sv (M) and the system music volume (Sv (M)) are recorded in the storage unit (database) 111. They are recorded as a reference value upon detecting the ambient sound of the ambient volume N.

After recording it as the reference value in the storage unit (database) 111, in the case of detecting an ambient sound of the ambient volume N, the music playback based on the system music volume reference value (Sv (M)) and the system utterance volume control based on the system utterance volume reference value (=Sv (T)) are performed.

Moreover, the music playback has two types.

They are BGM playback and music playback for listening to music other than BGM.

The volume of the BGM playback is caused to be lower than the volume used in playing back music for listening to music.

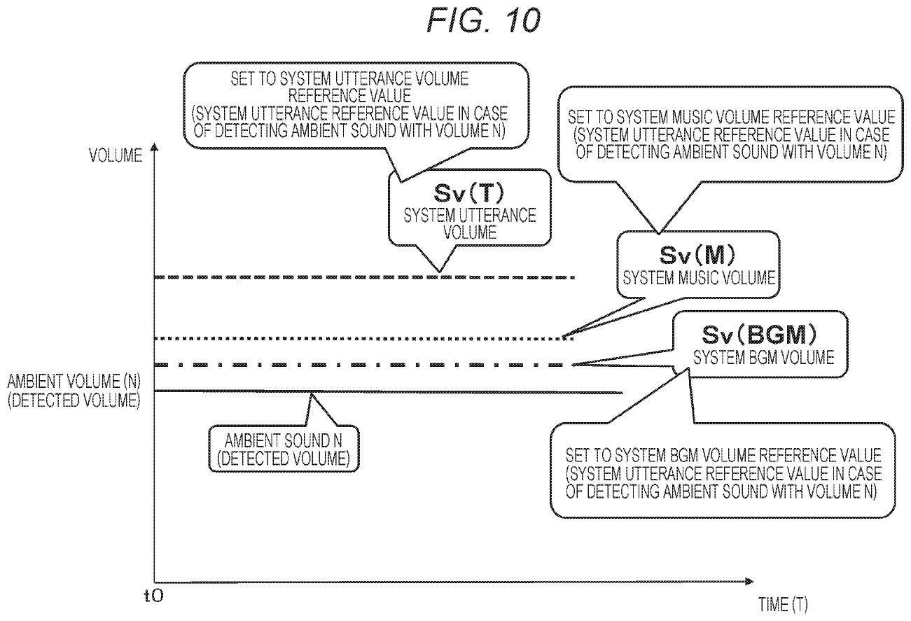

A specific example is illustrated in FIG. 10.

The graph shown in FIG. 10 is a graph in which time (T) is set on the horizontal axis and volume is set on the vertical axis, which is similar to FIG. 9.

It is assumed that ambient sound of fixed volume (N) is detected from the input of the speech input unit (microphone) 101. This is an ambient sound with the ambient volume N shown in FIG. 10.

FIG. 10 illustrates three volume types, in addition to the ambient sound of the ambient volume N, as follows:

System utterance volume (Sv (T))

System music volume (Sv (M))

System BGM volume (Sv (BGM))

These three volume types and the ambient volume N have the following relationship:

Sv(T)>Sv(M)>Sv(BGM)>N

As described above, the output (speech or image) control unit 110 of the information processing apparatus 100 performs control to set the system utterance volume (Sv (T)) to be the highest value, the music playback volume (Sv (M)) to be the next highest value, and then the BGM volume (Sv (BGM)) to be the lowest value. However, the volume levels are all set to be higher than the ambient volumes N.

This processing makes it possible for the user to listen to the system utterance at the volume (Sv (T)) higher than the ambient volume (N) or the system music volume (Sv (M)) or the system BGM volume (Sv (BGM)), resulting in eliminating the difficulty in listening to the system utterance.

Moreover, the system utterance volume Sv (M), the system music volume (Sv (M)), and the system BGM volume (Sv (BGM)) are recorded in the storage unit (database) 111. They are recorded as a reference value upon detecting the ambient sound of the ambient volume N.

After recording it as the reference value in the storage unit (database) 111, in the case of detecting an ambient sound of the ambient volume N, the music playback based on the system music volume reference value (Sv (M)) and the system utterance volume control based on the system utterance volume reference value (=Sv (T)), and the BGM playback based on the system BGM volume (Sv (BGM)) are performed.

[3-5. (Control Example 5) Control Example Considering Time Zone]

Next, as (Control Example 5), a control example considering time zone will be described.

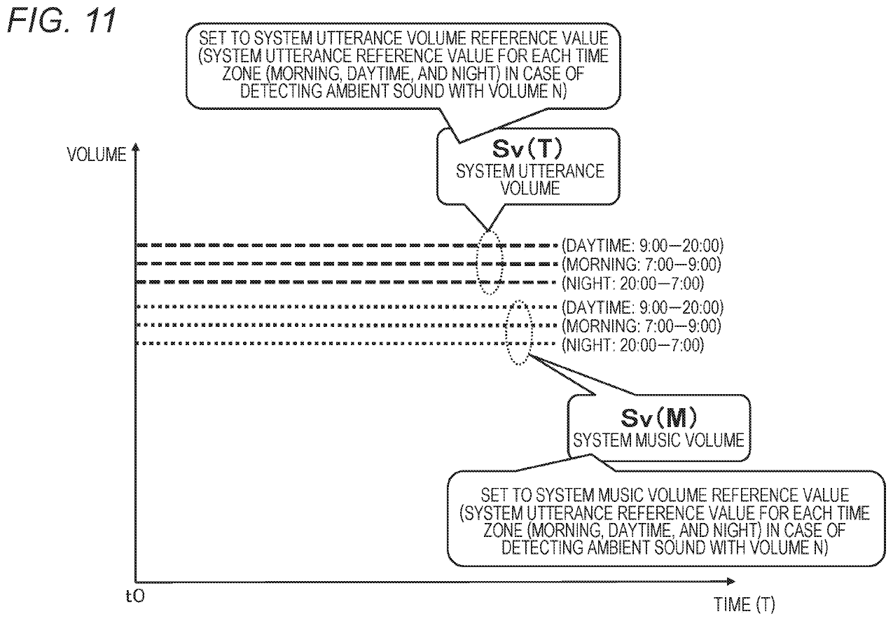

A description of a control example considering the time zone at which the output (speech or image) control unit 110 is executed is given with reference to FIG. 11.

The graph shown in FIG. 11 is a graph in which time (T) is set on the horizontal axis and volume is set on the vertical axis.

FIG. 11 illustrates two volume types for each time zone, as follows:

System utterance volume (Sv (T))

System music volume (Sv (M))

Both the system utterance volume (Sv (T)) and the system music volume (Sv (M)) indicate the respective volume for each of time zone divided into three as follows:

Daytime=9:00-20:00

Morning=7:00-9:00

Night=20:00-7:00

The volume of the system utterance volume (Sv (T)) in the time zone (daytime) is the highest, and the respective volume is set in the order as follows:

Time zone of system utterance volume (Sv (T)) (morning)

Time zone of system utterance volume (Sv (T)) (night)

Time zone of system music volume (Sv (M)) (daytime)

Time zone of system music volume (Sv (M)) (morning)

Time zone of system music volume (Sv (M)) (night)

This processing is the processing of performing control to change the volume depending on each time zone.

The volume in the daytime zone estimated to be a bustling environment is set to be highest, the next highest volume is set in the morning time zone, and then the lowest volume is set in a quiet night time zone.

This control makes it possible for the user to listen to the system utterance and the music being played at an optimum volume depending on each time zone.

Moreover, the volume information mentioned above is also recorded in the storage unit (database) 111. It is recorded as a reference value for each time zone.

After recording it as the reference value in the storage unit (database) 111, the output (speech or image) control unit 110 acquires a reference value corresponding to each time on the basis of the current time information and performs the volume control based on the acquired reference value.

[3-6. (Control Example 6) Control Example of Displaying System Utterance Contents on Display Unit]

Next, as (Control Example 6), a control example of displaying system utterance contents on the display unit will be described.

In the control processing based on (A) User distance and (B) User utterance volume described above with reference to FIGS. 4 and 5, there is the case where the processing of displaying the system utterance contents on the display unit, that is, the image output unit 125, is executed, in one example, in the part (a3-b1) or (a1-b3).

The output (speech or image) control unit 110 of the information processing apparatus 100 executes the control processing corresponding to the part (a3-b1) as follows:

The part (a3-b1) indicates

the control processing in the case where

(A) User distance is far distance and

(B) User utterance volume is higher than the reference volume (near).

In this case, the output (speech or image) control unit 110 estimates that the user utters much louder than ordinary on the basis of the fact that the user utterance volume is detected as volume higher than the reference volume (far).

Further, depending on the estimation, the processing of estimating that the system utterance is in a situation where the user is difficult to listen to and executing the control to increase the system utterance (control extent=large) is executed.

Furthermore, the processing of displaying the system utterance contents is executed depending on the contexts. In one example, as illustrated in FIG. 5, in the case where the system utterance volume reaches a predetermined maximum allowable value (Svmax), the processing of displaying the system utterance contents on the image output unit 125 is executed.

Further, the output (speech or image) control unit 110 executes the control processing corresponding to the part (a1-b3) as follows:

The part (a1-b3) indicates

the control processing in the case where

(A) User distance is near distance and

(B) User utterance volume is lower than the reference volume (near).

In this case, the output (speech or image) control unit 110 estimates that the user utters much lower than ordinary on the basis of the fact that the user utterance volume is detected as volume lower than the reference volume (near).

Further, depending on the estimation, the processing of estimating that the user desires to be much quiet and executing the control to decrease the system utterance (control extent=large) is executed.

Furthermore, the processing of stopping the system utterance depending on the contexts and displaying the system utterance contents on the image output unit 125 is executed. In one example, in a case where the system utterance volume is too low and reaches a level at which it is hardly listened, the display processing is performed on the display unit.

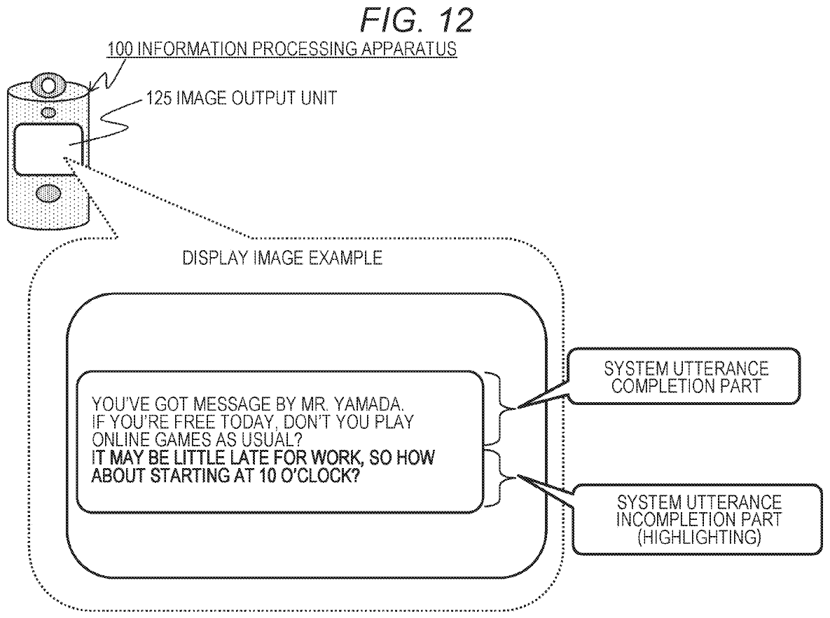

A display example in the case where the system utterance contents are displayed on the display unit is described with reference to FIG. 12.

As illustrated in FIG. 12, text data of the utterance contents of the system utterance is displayed on the image output unit 125 of the information processing apparatus 100.

The entire contents of the system utterance can be displayed as text, or only the text that is not yet uttered by the system can be displayed.

In addition, as the example illustrated in FIG. 12, the last part where the system utterance is completed and the beginning part where the system utterance is not completed can be distinguished and displayed.

In addition, the control to switch between a display of the entirety and a display of only the unuttered part of the system depending on the number of display location areas can be performed.

As described above, even in a case where there is important information in the latter half of the system utterance by presenting text that is not yet uttered by the system to the user as visual information, it is possible to present the important information to the user.

[3-7. (Control Example 7) Setting Example of for Each Control]

A setting example for each control as (Control Example 7) is now described.

In Control Examples 1 to 5 described above, the volume control examples of the system utterance volume, the system music volume, and the system BGM volume are described above.

However, in one example, the user distance is unfixed and varies during the execution of the system utterance in some cases. In addition, the ambient volume N of the ambient sound such as noise is unfixed and varies during the execution of the system utterance in some cases.

In such a case, the output (speech or image) control unit 110 of the information processing apparatus 100 performs processing of changing the volume of the system utterance volume, the system music volume, and the system BGM volume depending on the variations.

In addition, the volume can vary in response to the user's request in some cases.

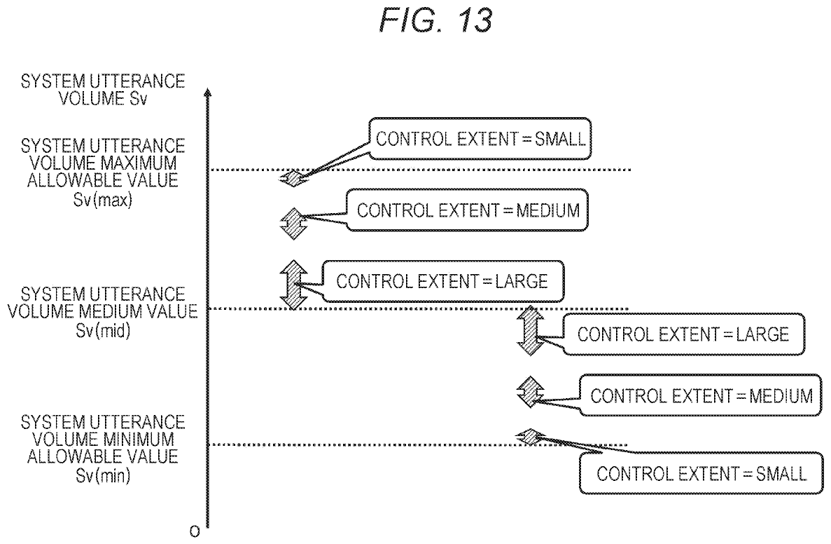

In the case where the volume is necessary to be changed due to these various factors, the output (speech or image) control unit 110 executes the volume change processing, in one example, in the mode illustrated in FIG. 13.

FIG. 13 shows the system utterance volume as the vertical axis.

The medium value is the system utterance volume medium value (Sv (mid)).

This system utterance volume medium value (Sv (mid)) is, for example, the part (a2-b2) illustrated in FIG. 4, that is,

(A) User distance as the medium distance (reference distance) and

(B) User utterance volume as the reference volume (medium).

This corresponds to the system utterance volume set in this case.

In one example, in a case where the current system utterance volume is near the “system utterance volume medium value (Sv (mid))”, the output (speech or image) control unit 110 changes the volume by setting the volume change range for one time to be larger.

On the other hand, as the current system utterance volume departs from the “system utterance volume medium value (Sv (mid))”, the volume change is performed by setting the volume change range for one time to be smaller.

Such processing allows the detailed control to be executed in the case where, in one example, the current system utterance volume is

close to values of

the maximum allowable value of system utterance volume (Sv (max)) and

the minimum allowable value of system utterance volume (Sv (min)).

Specifically, in one example, in a case where the volume control range is set to 100 equal parts from 0 (min) to 100 (max), the processing of setting each change to 1 in the sections from 0 to 10 and 90 to 100, and setting each change to 2 in the sections from 10 to 90 is performed.

[3-8. (Control Example 8) Other Control Examples]

Other control examples as (Control Example 8) are now described.

The plurality of control examples is described above for control examples of the volume control of system utterance, system music, and system BGM, but the following control can be further performed:

(a) Volume control depending on type of information (content) output from the information processing apparatus 100

(b) Volume control depending on importance of information (content) output from the information processing apparatus 100

(c) Volume control depending on various types of context information (context)

Specific examples are now described.

(a) Volume Control Depending on Type of Information (Content) Output from the Information Processing Apparatus 100

In one example, there are various types of information output from the information processing apparatus 100, for example, as follows:

Response to user

Calls to user

Notice to user

Readout of incoming email

Music

BGM

News

The output (speech or image) control unit 110 of the information processing apparatus 100 can perform control to set an optimum output volume, in one example, for each of pieces of information (content).

(b) Volume Control Depending on Importance of Information (Content) Output from the Information Processing Apparatus 100

The information (content) output from the information processing apparatus 100 includes various types of information having important information, for example, important information such as earthquake information or disaster information, less important information, for example, information such as general news, and the like

The output (speech or image) control unit 110 of the information processing apparatus 100 can perform control in such a way that important information is set as higher volume and unimportant information is set as lower volume, or the like.

(c) Volume Control Depending on Various Types of Context Information (Context)

Furthermore, the output (speech or image) control unit 110 of the information processing apparatus 100 can perform volume control depending on various types of context information (context).

As described above with reference to FIG. 3, the output (speech or image) control unit 110 of the information processing apparatus 100

receives the following inputs:

(1) User speech and other sound information detected by the speech separation unit 102 on the basis of the user utterance

(2) Intention (intent) and entity information (entity) of the user utterance generated by executing natural-language understanding (NLU) on text data in the utterance semantic analysis unit 104

(3) Result information of image recognition by the image recognition unit 106 on images of the uttering user and the surroundings acquired by the image input unit 105 such as a camera

(4) Sensor analysis information analyzed by the sensor information analysis unit 108 on the basis of the detected information of the uttering user and the surrounding state acquired by the sensor 107

(5) User information and data for system utterance control (reference value) acquired from the storage unit (database) 111

The output (speech or image) control unit 110 is capable of acquiring various types of context information (context), that is, context information (context) of the space where the user is present on the basis of the input information mentioned above. Examples thereof include as follows:

Number of persons in front of the information processing apparatus 100

Information regarding whether or not a person in front of the information processing apparatus 100 is in a conversation

Source of ambient sound (such as human conversation, TV sound, or air conditioner sound)

Information regarding the atmosphere (positive or negative atmosphere) in front of the information processing apparatus 100

In one example, the output (speech or image) control unit 110 is capable of acquiring these various types of context information (context).

Moreover, for the information regarding the atmosphere (positive atmosphere or negative atmosphere) in front of the information processing apparatus 100, in one example, it is possible to determine that the information is positive in a case where the laughter is included in the user's speech and that the information is negative if not.

In addition, it is possible to determine that the information is positive in a case where a smiling face is detected from images of the uttering user and surroundings acquired by the image input unit 105 such as a camera and determine that the information is negative if not.

The output (speech or image) control unit 110 is capable of controlling the output volume depending on these various types of context information (context).

In one example, in a case where a plurality of persons is detected and talking with each other, the system utterance volume is decreased.

In addition, in the case where the atmosphere in front of the information processing apparatus 100 is a positive atmosphere, the system utterance volume is increased, and in the case where the atmosphere is negative, the system utterance volume is decreased.

Moreover, in the case where the atmosphere is negative, a change is made to the atmosphere in the place, and conversely, a control for increasing the system utterance can be performed.

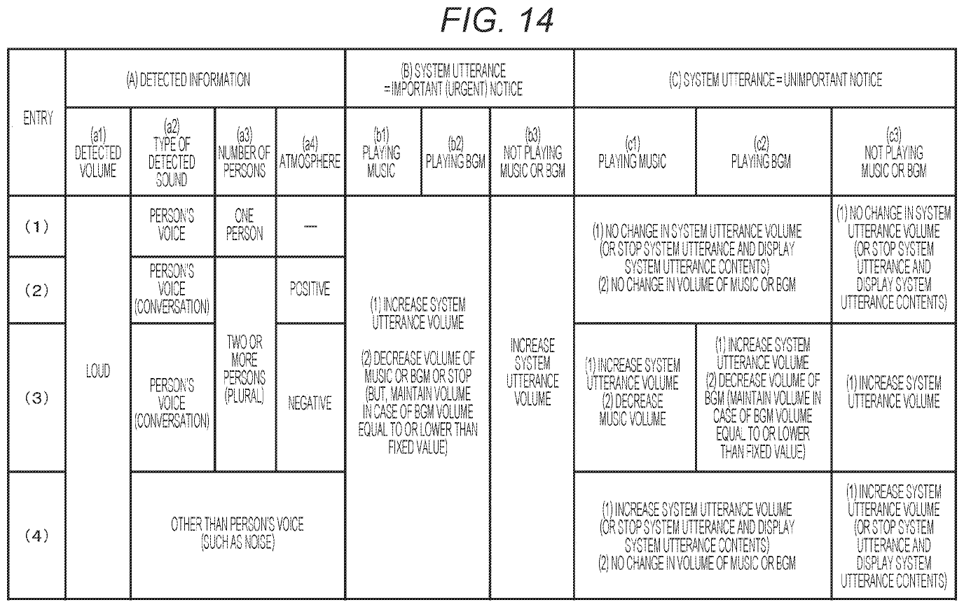

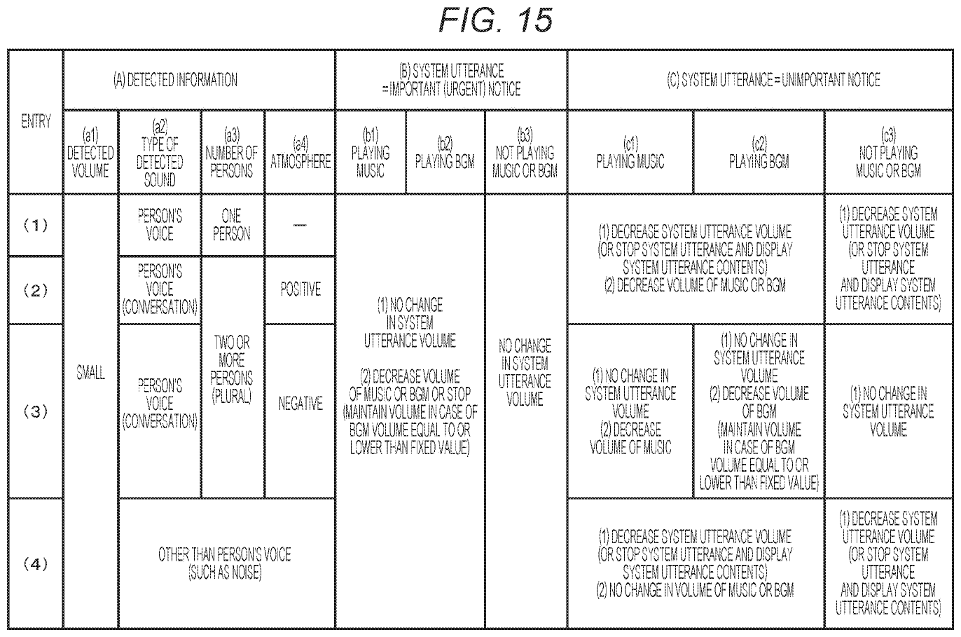

A specific example of the control processing of the system utterance volume using the context information is described with reference to FIGS. 14 and 15.

FIG. 14 is a control processing example in a case where the detected volume that is input through the speech input unit 101 is high.

FIG. 15 is a control processing example in a case where the detected volume that is input through the speech input unit 101 is low.

A description is now given of a control processing example in the case where the detected volume that is input through the speech input unit 101 is high with reference to FIG. 14.

(A) Detected information is listed as follows:

(a1) Detected volume

(a2) Type of detected sound

(a3) Number of detected persons

(a4) Atmosphere

FIG. 14 shows output control modes of two types of system utterances depending on a combination of these pieces of detected information, as follows:

(B) System utterance (important (urgent) notice)

(C) System utterance (unimportant notice)

Moreover, for each of (B) and (C),

the volume control mode for each case is listed as follows:

(b1) and (c1) Playing music

(b2) and (c2) Playing BGM

(b3) and (c3) Not playing music or BGM

Moreover, the volume control target is the system utterance volume, the system music volume, and the system BGM volume.

The output (speech or image) control unit 110 of the information processing apparatus 100 executes such volume control.

The control examples depending on a combination of detected information are now described.

The description is given in the order of Entries (1) to (4) illustrated in FIG. 14.

Control Processing of Entry (1)

Entry (1) is the processing in a case where (A) Detected information is a combination as follows:

(a1) Detected volume=loud

(a2) Type of detected sound=person's voice

(a3) Number of detected persons=1

(a4) Atmosphere=unknown

In the case where these pieces of detected information are input, the output (speech or image) control unit 110 executes the volume control as follows.

The processing in the case where (B) System utterance is important (urgent) notice is listed as follows:

(b1) and (b2) Case of playing music or BGM

(1) Increase system utterance volume

(2) Decrease volume of music or BGM or stop

However, in a case where the BGM volume is equal to or lower than a predefined fixed value, the BGM continues while maintaining the volume.

(b3) Case of not playing music or BGM,

(1) Increase system utterance volume

Further, the processing in the case where (C) System utterance is unimportant notice is listed as follows:

(c1) and (c2) Case of playing music or BGM

(1) No change in volume levels of system utterance

Alternatively, stop the system utterance and display the system utterance contents on the display unit

(2) No change in volume levels of music and BGM

(c3) Case of not playing music or BGM,

(1) No change in volume levels of system utterance

Alternatively, stop the system utterance and display the system utterance contents on the display unit

Control Processing of Entry (2)

Entry (2) is the processing in a case where (A) Detected information is a combination as follows:

(a1) Detected volume=loud

(a2) Type of detected sound=person's voice

(a3) Number of detected persons=two or more (plural)

(a4) Atmosphere=positive

In a case where the detected information mentioned above is input, the volume control processing performed by the output (speech or image) control unit 110 is similar to the processing in the case of Entry (1) described above.

Control Processing of Entry (3)

Entry (3) is the processing in a case where (A) Detected information is a combination as follows:

(a1) Detected volume=loud

(a2) Type of detected sound=person's voice

(a3) Number of detected persons=two or more (plural)

(a4) Atmosphere=negative

In the case where these pieces of detected information are input, the output (speech or image) control unit 110 executes the volume control as follows.

The processing in the case where (B) System utterance is important (urgent) notice is listed as follows:

(b1) and (b2) Case of playing music or BGM

(1) Increase system utterance volume

(2) Decrease volume of music or BGM or stop

However, in a case where the BGM volume is equal to or lower than a predefined fixed value, the BGM continues while maintaining the volume.

(b3) Case of not playing music or BGM,

(1) Increase system utterance volume

Further, the processing in the case where (C) System utterance is unimportant notice is listed as follows:

(c1) Case of playing music

(1) Increase the system utterance volume.

(2) Decrease the music volume.

(c2) Case of playing BGM

(1) Increase the system utterance volume.

(2) Decrease volume of BGM

However, in a case where the BGM volume is equal to or lower than a predefined fixed value, the BGM continues while maintaining the volume.

(c3) Case of not playing music or BGM

(1) Increase the system utterance volume.

Control Processing of Entry (4)

Entry (4) is the processing in a case where (A) Detected information is a combination as follows:

(a1) Detected volume=loud

(a2) Type of detected sound=other than person's voice (noise or the like)

In the case where these pieces of detected information are input, the output (speech or image) control unit 110 executes the volume control as follows.

The processing in the case where (B) System utterance is important (urgent) notice is listed as follows:

(b1) and (b2) Case of playing music or BGM

(1) Increase system utterance volume

(2) Decrease volume of music or BGM or stop

However, in a case where the BGM volume is equal to or lower than a predefined fixed value, the BGM continues while maintaining the volume.

(b3) Case of not playing music or BGM,

(1) Increase system utterance volume

Further, the processing in the case where (C) System utterance is unimportant notice is listed as follows:

(c1) Case of playing music or BGM

(1) Increase the system utterance volume.

Alternatively, stop the system utterance and display the system utterance contents on the display unit

(2) No change in volume levels of music and BGM

(c3) Case of not playing music or BGM

(1) Increase the system utterance volume.

Alternatively, stop the system utterance and display the system utterance contents on the display unit

The volume control processing illustrated in FIG. 14 is a control in which, in one example, music that the user is actively listening to or a human conversation (in a positive case) is set so as not to disturb as much as possible.

However, in the case where the system utterance is an important notice, make sure that it delivers even if it is disturbed.

In addition, in the case where the atmosphere is negative, to give a change to the atmosphere of the place, the control is made to actively increase the system utterance even for unimportant notice.

A description is now given of a control processing example in the case where the detected volume that is input through the speech input unit 101 is low with reference to FIG. 15.

The description is made in the order of Entries (1) to (4) listed in FIG. 15.

Control Processing of Entry (1)

Entry (1) is the processing in a case where (A) Detected information is a combination as follows:

(a1) Detected volume=low

(a2) Type of detected sound=person's voice

(a3) Number of detected persons=1

(a4) Atmosphere=unknown

In the case where these pieces of detected information are input, the output (speech or image) control unit 110 executes the volume control as follows.

The processing in the case where (B) System utterance is important (urgent) notice is listed as follows:

(b1) and (b2) Case of playing music or BGM

(1) No change in volume levels of system utterance

(2) Decrease volume of music or BGM or stop

However, in a case where the BGM volume is equal to or lower than a predefined fixed value, the BGM continues while maintaining the volume.

(b3) Case of not playing music or BGM

(1) No change in volume levels of system utterance

Further, the processing in the case where (C) System utterance is unimportant notice is listed as follows:

(c1) and (c2) Case of playing music or BGM

(1) Decrease the system utterance volume

Alternatively, stop the system utterance and display the system utterance contents on the display unit

(2) Decrease volume of music or BGM

(c3) Case of not playing music or BGM

(1) Decrease the system utterance volume

Alternatively, stop the system utterance and display the system utterance contents on the display unit

Control Processing of Entry (2)

Entry (2) is the processing in a case where (A) Detected information is a combination as follows:

(a1) Detected volume=low

(a2) Type of detected sound=person's voice

(a3) Number of detected persons=two or more (plural)

(a4) Atmosphere=positive

In a case where the detected information mentioned above is input, the volume control processing performed by the output (speech or image) control unit 110 is similar to the processing in the case of Entry (1) described above.

Control Processing of Entry (3)

Entry (3) is the processing in a case where (A) Detected information is a combination as follows:

(a1) Detected volume=low

(a2) Type of detected sound=person's voice

(a3) Number of detected persons=two or more (plural)

(a4) Atmosphere=negative

In the case where these pieces of detected information are input, the output (speech or image) control unit 110 executes the volume control as follows.

The processing in the case where (B) System utterance is important (urgent) notice is listed as follows:

(b1) and (b2) Case of playing music or BGM

(1) No change in volume levels of system utterance

(2) Decrease volume of music or BGM or stop

However, in a case where the BGM volume is equal to or lower than a predefined fixed value, the BGM continues while maintaining the volume.

(b3) Case of not playing music or BGM

(1) No change in volume levels of system utterance

Further, the processing in the case where (C) System utterance is unimportant notice is listed as follows:

(c1) Case of playing music

(1) No change in volume levels of system utterance

(2) Decrease the music volume.

(c2) Case of playing BGM

(1) No change in volume levels of system utterance

(2) Decrease volume of BGM

However, in a case where the BGM volume is equal to or lower than a predefined fixed value, the BGM continues while maintaining the volume.

(c3) Case of not playing music or BGM,

(1) No change in volume levels of system utterance

Control Processing of Entry (4)

Entry (4) is the processing in a case where (A) Detected information is a combination as follows:

(a1) Detected volume=low

(a2) Type of detected sound=other than person's voice (noise or the like)

In the case where these pieces of detected information are input, the output (speech or image) control unit 110 executes the volume control as follows.

The processing in the case where (B) System utterance is important (urgent) notice is listed as follows:

(b1) and (b2) Case of playing music or BGM

(1) No change in volume levels of system utterance

(2) Decrease volume of music or BGM or stop

However, in a case where the BGM volume is equal to or lower than a predefined fixed value, the BGM continues while maintaining the volume.

(b3) Case of not playing music or BGM

(1) No change in volume levels of system utterance

Further, the processing in the case where (C) System utterance is unimportant notice is listed as follows:

(c1) Case of playing music or BGM

(1) Decrease the system utterance volume

Alternatively, stop the system utterance and display the system utterance contents on the display unit

(2) No change in volume levels of music and BGM

(c3) Case of not playing music or BGM

(1) Decrease the system utterance volume

Alternatively, stop the system utterance and display the system utterance contents on the display unit

The volume control processing illustrated in FIG. 15 is the processing performed in the case where the detected volume is low, and it is estimated that the user has a desire to keep quiet. In this case, notification of important system utterance is given by increasing the sound volume, but the other sound volumes are caused to be set lower overall.

The control examples are described above as the control examples executed by the output (speech or image) control unit 110, as follows:

(Control Example 1) Control example corresponding to distance between information processing apparatus and user

(Control Example 2) Control example corresponding to ambient sound

(Control Example 3) Control example in response to user request

(Control Example 4) Control example considering system output sound (such as music) other than system utterance

(Control Example 5) Control example considering time zone

(Control Example 6) Control example of displaying system utterance contents on the display unit

(Control Example 7) Setting example for each control

(Control Example 8) Other control examples

As described above, Control Examples 1 to 8 are individually described in order to facilitate understanding of the processing. However, the information processing apparatus 100 of the present disclosure is capable of executing Control Examples 1 to 8 individually or in any combination thereof.

[4. Regarding Processing Sequence Executed by Information Processing Apparatus]

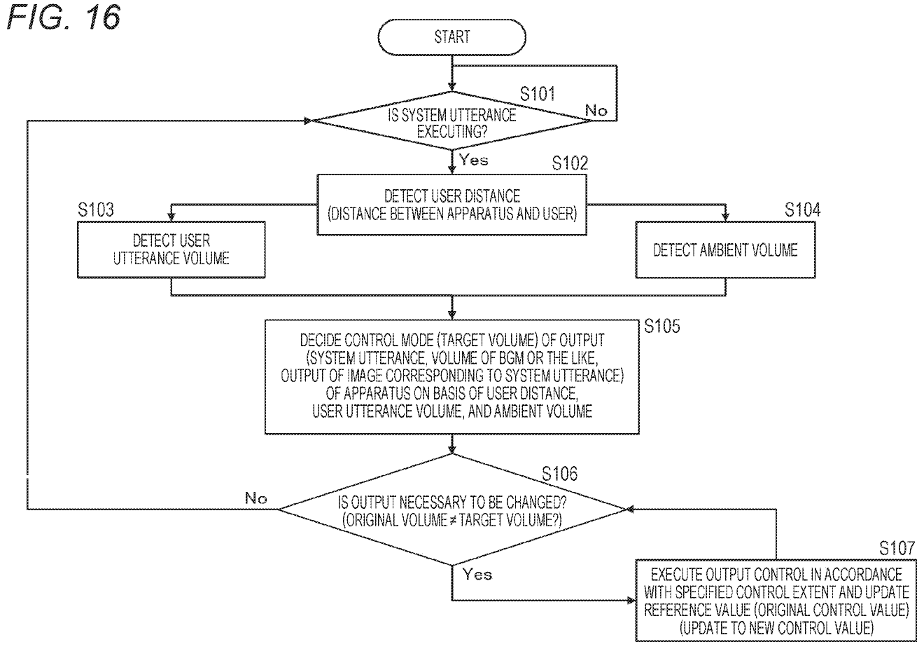

A sequence of processing executed by the information processing apparatus 100 is now described with reference to the flowcharts illustrated in FIG. 16 and the subsequent drawings.

Moreover, as described above, the information processing apparatus 100 is capable of performing the processing by variously combining, in one example, (Control Example 1) to (Control Example 8) described above.

The flowcharts shown in FIGS. 16, 17, and 18 are typical processing examples of the processing executed by the information processing apparatus 100, and examples thereof are as follows:

(Processing Example 1) Volume control processing based on user distance, user utterance volume, ambient volume, or the like (FIG. 16)

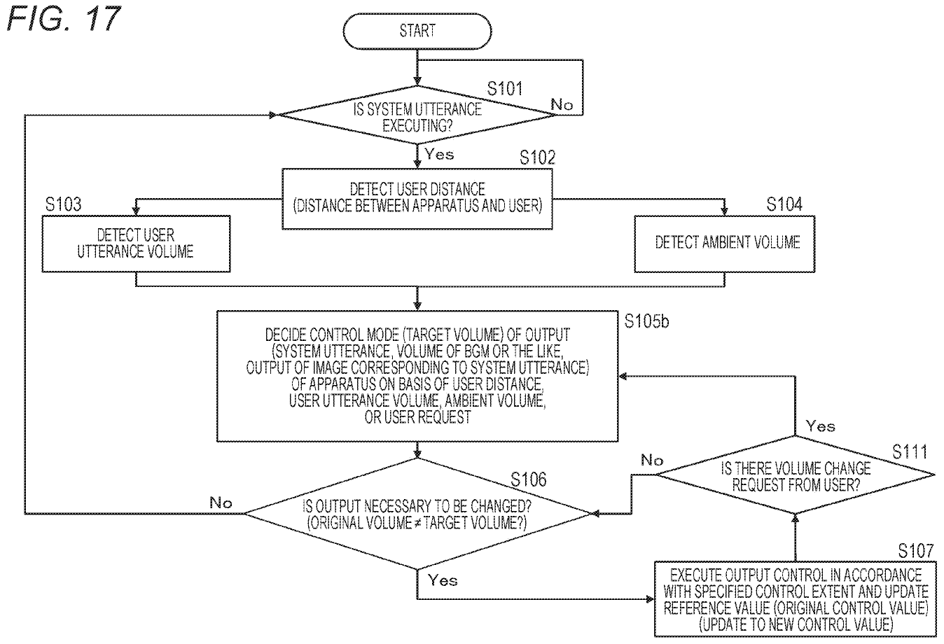

(Processing Example 2) Volume control processing based on user distance, user utterance volume, ambient volume, user request, or the like (FIG. 17)

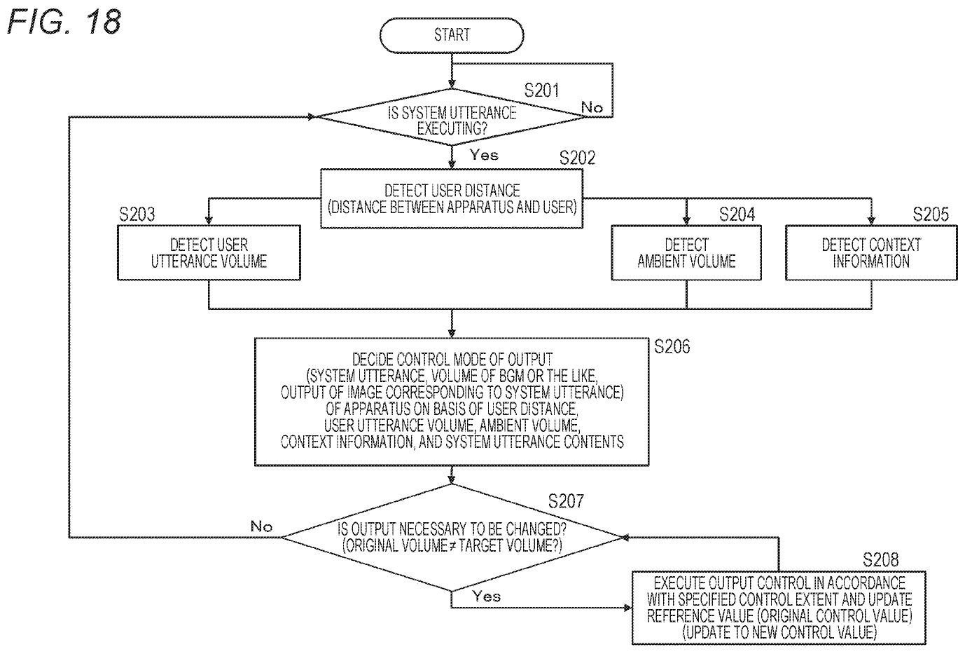

(Processing Example 3) Volume control processing based on user distance, user utterance volume, ambient volume, context information (context), or the like (FIG. 18)

These three types of processing examples are now sequentially described with reference to the flowcharts shown in FIGS. 16, 17, and 18.

[4-1. (Processing Example 1) Volume Control Processing Based on User Distance, User Utterance Volume, Ambient Volume, or the Like]

(Processing Example 1) of the volume control processing based on a user distance, a user utterance volume, an ambient volume, or the like is now described with reference to FIG. 16.

Moreover, the processing according to the flowcharts illustrated in FIG. 16 and subsequent drawings is, in one example, the volume control processing executed by the output (speech or image) control unit 110 of the information processing apparatus 100.

The processing according to this procedure can be executed in accordance with a program stored in the storage unit and can be executed, in one example, as program execution processing by a processor such as a CPU having a program execution function.

The processing of each step of the procedure illustrated in FIG. 16 is now described.

(Step S101)

In step S101, at first, it is determined whether or not the information processing apparatus 100 executes system utterance. If the system utterance is being executed, the processing of step S102 and subsequent steps is executed.

(Step S102)

Then, in step S102, the output (speech or image) control unit 110 of the information processing apparatus 100 calculates the user distance, that is, the distance between the information processing apparatus 100 and the uttering user.

This calculation of the user distance is performed by the output (speech or image) control unit 110 on the basis of the captured image acquired by the image input unit 105.

Alternatively, in a case where a distance measurement sensor is provided as the sensor 107, measurement information of this distance measurement sensor can be used.

(Steps S103 and S104)

Then, the processing of steps S103 and S104 is executed as parallel processing.

The output (speech or image) control unit 110 calculates the user utterance volume in step S103.

Furthermore, in step S104, the ambient volume other than the user's utterance is calculated.

As described with reference to FIG. 3 above, the speech input unit (microphone) 101 inputs, to the speech separation unit 102, speech data including the user utterance speech that is input.

The speech separation unit 102 separates, from the input speech data, the user utterance speech and other ambient sounds, for example, other sounds including music and noise such as air conditioner sound.

The speech separation unit 102 has, in one example, a voice activity detection (VAD) function. VAD is a technique that enables the user utterance speech and environmental noise to be distinguished from an input sound signal to specify a period during which the user's speech is uttered.

The user utterance speech and the ambient sound separated by the speech separation unit 102 are input to the output (speech or image) control unit 110.

The output (speech or image) control unit 110 calculates the user utterance volume and the ambient volume on the basis of the input information mentioned above.

(Step S105)

Then, in step S105, the output (speech or image) control unit 110 decides a control mode (such as target volume) of an output of the information processing apparatus 100, that is, the volume of system utterance, music, BGM, or the like, and an output of an image output or the like corresponding to the system utterance. This decision is performed on the basis of the user distance, the user utterance volume, and the ambient volume.

This processing is, in one example, the processing described above with reference to FIGS. 4 and 5, that is, the processing based on the control example depending on the distance between the information processing apparatus and the user described as (Control Example 1).

Specifically, the processing is executed of deciding which of the parts (a1-b1) to (a3-b3) shown in the table of FIG. 4 the combination of the calculated user distance and user utterance volume corresponds to and the processing corresponding to the part(s) is executed.

Moreover, if the combination of the calculated user distance and user utterance volume corresponds to the parts (a1-b2), (a2-b2), and (a3-b2) shown in the table of FIG. 4, the control is performed in accordance with the normal system utterance volume control line (Sv (c1)) illustrated in FIG. 5.

This normal system utterance volume control line (Sv (c1)) is stored in the storage unit of the information processing apparatus 100.

However, in step S105, the processing is performed in consideration of the volume of the ambient sound. This is a control example depending on the ambient sound described above as (Control Example 2).

In other words, the processing in step S105 is the processing in which

the control processing depending on the distance between the information processing apparatus and the user described as (Control Example 1) and

the control processing depending on the ambient sound described as (Control Example 2)

are combined.

Moreover,

(Control Example 6) as the control example of displaying contents of the system utterance on the display unit is also applied depending on the context.

The control processing depending on the ambient sound described as (Control Example 2) is the processing described above with reference to FIG. 6, and is the processing of setting the system utterance volume to be higher than the ambient volume.

In step S105, the output (speech or image) control unit 110 applies (Control Example 2) as the control for setting the system utterance volume to be higher than the ambient volume, and applies (Control Example 1) as the control depending on the user utterance volume and the user distance to decide the final control mode. Depending on the context, (Control Example 6) as the control example of displaying the system utterance content on the display unit is also applied.

(Step S106)

Then, in step S106, the output (speech or image) control unit 110 determines whether or not the control mode (such as target volume) decided in step S105 is different from the current set volume and the output is necessary to be changed.

If it is determined that the output is necessary to be changed (original output≠target output), the processing proceeds to step S107.

If it is determined that the output is not necessary to be changed (original output=target output), that is, the current output is to be maintained, the processing returns to step S101.

(Step S107)

If it is determined in step S106 that the output is necessary to be changed (original output≠target output), the processing proceeds to step S107.

In step S107, the output (speech or image) control unit 110 performs output control in accordance with the specified control extent.

In other words, the volume is changed with the control range defined depending on the current value of the system utterance volume in accordance with “(Control Example 7) setting example for each control” described above with reference to FIG. 13.

In step S107, the processing of updating a reference value (original control value) is further executed (updating to a new control value).

The processing of steps S106 to 5107 is repeated until it is determined in step S106 that the output is not necessary to be changed (original output=target output).

If it is determined in step S106 that the output is not necessary to be changed (original output=target output), the processing returns to step S101, and if the system utterance is being executed, the processing of step S102 and subsequent steps is repeated.

In this stage, in one example, if there is a change in values of user distance, user utterance volume, or ambient volume, a new control mode (target volume) is decided in step S105, and the control based on the new control mode (target volume) is executed in steps S106 to S107.

Moreover, the control target in step S107 is, in one example, the volume of system utterance, music, BGM, and the like.

For the system utterance, the contents of the system utterance are output to the display unit (the image output unit 125) in some cases.

In addition, the reference values (the new control values) updated in step S107 are volume levels or the like of a system utterance, music, BGM, or the like after updated or the like, and these values are stored in the storage unit (database) 111.

The reference value stored in the storage unit (database) 111 is used in subsequent processing under a similar environment. In other words, it is used for the volume control in a case of detecting similar ambient sound, or the like.

Moreover, the output reference value registered in the storage unit (database) is a reference value for each volume such as system utterance, music, and BGM.

Each of these reference values is registered in the storage unit (database) 111 as reference values corresponding to a predetermined user distance, user utterance volume, and ambient volume.

[4-2. (Processing Example 2) Volume Control Processing Based on User Distance, User Utterance Volume, Ambient Volume, User Request, or the Like]

Then, (Processing Example 2) as the volume control processing based on a user distance, a user utterance volume, an ambient volume, a user request, and the like is described with reference to FIG. 17.

This Processing Example 2 is the processing in which “(Control Example 3) Control example in response to user request” described with reference to FIGS. 7 and 8 is added to (Processing Example 1) described with reference to FIG. 16.

The processing of steps S101 to S104 in the flowchart illustrated in FIG. 17 is similar to the processing of steps S101 to S104 of the procedure described with reference to FIG. 16, so the description thereof is omitted, and the processing of step S105b and subsequent steps is described.

(Step S105b)

In steps S102 to S104, the output (speech or image) control unit 110 which acquired the user distance, the user utterance volume, and the ambient volume decides, in step S105b,

a control mode (such as target volume) of an output of the information processing apparatus 100, that is, the volume of system utterance, music, BGM, or the like, and an output of an image output or the like corresponding to the system utterance. This decision is performed on the basis of

(a) the user distance, the user utterance volume, and the ambient volume, or

(b) the user request.

Moreover, if there is no user request, the control mode (such as target volume) decision processing based on the user distance, the user utterance volume, and the ambient volume is executed.

The processing, in this case, is similar to the processing of step S105 described with reference to FIG. 16.

On the other hand, if there is a user request, the control mode (such as target volume) decision processing based on the user request is executed.

The control mode (such as target volume) decision processing based on the user request is the processing in accordance with “(Control Example 3) Control example in response to user request” described above with reference to FIGS. 7 and 8.

As described in (Control Example 3), the preferred volume of the system utterance differs depending on the user. The procedure illustrated in FIG. 17 is the control procedure in which an optimal system utterance volume depending on each user's preference is settable.

(Step S106)

Then, in step S106, the output (speech or image) control unit 110 determines whether or not the control mode (such as target volume) decided in step S105 is different from the current set volume and the output is necessary to be changed.

If it is determined that the output is necessary to be changed (original output≠target output), the processing proceeds to step S107.

If it is determined that the output is not necessary to be changed (original output=target output), that is, the current output is to be maintained, the processing returns to step S101.

(Step S107)

If it is determined in step S106 that the output is necessary to be changed (original output≠target output), the processing proceeds to step S107.

In step S107, the output (speech or image) control unit 110 performs output control in accordance with the specified control extent.

In other words, the volume is changed with the control range defined depending on the current value of the system utterance volume in accordance with “(Control Example 7) setting example for each control” described above with reference to FIG. 13.

In step S107, the processing of updating a reference value (original control value) is further executed (updating to a new control value).

(Step S111)

After executing the control processing in step S107, it is determined in step S111 whether or not there is a volume change request from the user.

This is the processing corresponding to “(Control Example 3) Control example in response to user request” described above with reference to FIGS. 7 and 8.

In one example, the user performs the user utterance as follows:

User utterance=Louder

This user utterance is input from the speech input unit (microphone) 101 to the speech recognition unit 103 and the utterance semantic analysis unit 104, and is analyzed that the user desires to increase the volume of the system utterance. This analysis result is input to the output (speech or image) control unit 110.

If such a user request is detected in step S111, the determination in step S111 is Yes, and the processing proceeds to step S105b.

The output (speech or image) control unit 110 executes the control mode (such as target volume) decision processing based on the user request in step S105b.

Then, in S106, a difference between the control mode (such as target volume) based on the user request and the original setting (volume) is determined, and in step S107, the control processing for approaching the control mode (such as target volume) based on the user request is executed.

On the other hand, if no user request is detected in step S111, the determination in step S111 is No, and the processing proceeds to step S106.

In step S106, the difference between the control mode (such as target volume) based on the user distance, the user utterance volume, and the ambient volume that is decided in step S105b and the original setting (volume) is determined. In step S107, the control processing is performed for approaching the control mode (such as target volume) based on the user distance, the user utterance volume, and the ambient volume.

The processing of steps S105b to S111 is repeated until it is determined in step S106 that the output is not necessary to be changed (original output=target output).

If it is determined in step S106 that the output is not necessary to be changed (original output=target output), the processing returns to step S101, and if the system utterance is being executed, the processing of step S102 and subsequent steps is repeated.

Moreover, the control target in step S107 is, in one example, the volume of system utterance, music, BGM, and the like.

For the system utterance, the contents of the system utterance are output to the display unit (the image output unit 125) in some cases.

In addition, the reference values (the new control values) updated in step S107 are volume levels or the like of a system utterance, music, BGM, or the like after updated or the like, and these values are stored in the storage unit (database) 111.

In addition, if the reference value (new control value) is updated by a user request, the reference value (new control value) is recorded as a user-specific reference value. In other words, it is stored in the storage unit (database) 111 in association with the user identifier.

The user-specific reference value stored in the storage unit (database) 111 is used in subsequent processing under a similar environment. In other words, it is used for the volume control in a case of detecting the same user and similar ambient sound or the like.

Moreover, the output reference value registered in the storage unit (database) is a reference value for each volume such as system utterance, music, and BGM.

Each of these reference values corresponds to a specific user, and is registered in the storage unit (database) 111 as reference values corresponding to a specific user distance, user utterance volume, and ambient volume.

[4-3. (Processing Example 3) Volume Control Processing Based on User Distance, User Utterance Volume, Ambient Volume, Context Information (Context), or the Like]

Then, (Processing Example 3) as the volume control processing based on user distance, user utterance volume, ambient volume, context information (context), and the like is now described with reference to FIG. 18.

Processing Example 3 is the processing obtained by adding “(c) Volume control depending on various types of context information (context)” described as “(Control Example 8) Other control examples” to (Processing Example 1) described with reference to FIG. 16.

As described above in “(c) Volume control depending on various types of context information (context)” as one of “(Control Example 8) Other control examples”, the output (speech or image) control unit 110 is capable of acquiring various types of context information (context) on the basis of the input information through the speech input unit 101 such as a microphone, the image input unit 105 such as a camera, and even the sensor 107, or the like. Examples thereof include as follows:

Number of persons in front of the information processing apparatus 100

Information regarding whether or not a person in front of the information processing apparatus 100 is in a conversation

Source of ambient sound (such as human conversation, TV sound, or air conditioner sound)

Information regarding the atmosphere (positive or negative atmosphere) in front of the information processing apparatus 100

In one example, the output (speech or image) control unit 110 is capable of acquiring these various types of context information (context).

The output (speech or image) control unit 110 is capable of controlling the output volume depending on these various types of context information (context).

In one example, in a case where a plurality of persons is detected and talking with each other, the system utterance volume is decreased.

In addition, in the case where the atmosphere in front of the information processing apparatus 100 is a positive atmosphere, the system utterance volume is increased, and in the case where the atmosphere is negative, the system utterance volume is decreased.

Moreover, in the case where the atmosphere is negative, a change is made to the atmosphere in the place, and conversely, a control for increasing the system utterance can be performed.

The flowchart shown in FIG. 18 is a flowchart to describe a processing sequence in the case where the output (speech or image) control unit 110 performs the output control using the context information (context).

The processing of steps S201 to S204 in the flowchart illustrated in FIG. 18 is similar to the processing of steps S101 to S104 of the procedure described with reference to FIG. 16, so the description thereof is omitted, and the processing of step S205 and subsequent steps is described.

(Step S205)

Step S205 is the processing of detecting context information (context) by the output (speech or image) control unit 110.

This step is the processing of acquiring various types of context information (context) on the basis of the input information of the output (speech or image) control unit 110, for example, information input through the speech input unit 101 such as a microphone, the image input unit 105 such as a camera, and even the sensor 107, or the like. Examples thereof include as follows:

Number of persons in front of the information processing apparatus 100

Information regarding whether or not a person in front of the information processing apparatus 100 is in a conversation

Source of ambient sound (such as human conversation, TV sound, or air conditioner sound)

Information regarding the atmosphere (positive or negative atmosphere) in front of the information processing apparatus 100

In one example, the output (speech or image) control unit 110 is capable of acquiring these various types of context information (context).

Moreover, the output (speech or image) control unit 110 calculates the user utterance volume in step S203, calculates the ambient volume other than the user utterance in step S204. The processing of detecting the context information (context) in step S205 is executed in parallel with the processing of steps S203 and S204.

(Step S206)

Then, in step S206, the output (speech or image) control unit 110 decides a control mode (such as target volume) of an output of the information processing apparatus 100, that is, the volume of system utterance, music, BGM, or the like, and an output of an image output or the like corresponding to the system utterance. This decision is performed on the basis of the user distance, the user utterance volume, the ambient volume, and further, the context information (context).

The control mode (such as target volume) decision processing based on the user distance, the user utterance volume, and the ambient volume is similar to the processing of step S105 described above with reference to FIG. 16.

In Processing Example 3, the output of the information processing apparatus 100 is further decided on the basis of the context information (context).

Specific processing modes include, for example, the following processing as described above.

In a case where a plurality of persons is detected and talking with each other, the system utterance volume is decreased.

In addition, in the case where the atmosphere in front of the information processing apparatus 100 is a positive atmosphere, the system utterance volume is increased, and in the case where the atmosphere is negative, the system utterance volume is decreased.

Moreover, in the case where the atmosphere is negative, a change is made to the atmosphere in the place, and conversely, a control for increasing the system utterance can be performed.

The processing of the next steps S207 to S208 is similar to the processing of steps S106 to S107 described above with reference to FIG. 16.

(Step S207)

Then, in step S207, the output (speech or image) control unit 110 determines whether or not the control mode (such as target volume) decided in step S206 is different from the current set volume and the output is necessary to be changed.

If it is determined that the output is necessary to be changed (original output≠target output), the processing proceeds to step S208.

If it is determined that the output is not necessary to be changed (original output=target output), that is, the current output is to be maintained, the processing returns to step S201.

(Step S208)

If it is determined in step S207 that the output is necessary to be changed (original output≠target output), the processing proceeds to step S208.

In step S208, the output (speech or image) control unit 110 performs output control in accordance with the specified control extent.

In other words, the volume is changed with the control range defined depending on the current value of the system utterance volume in accordance with “(Control Example 7) setting example for each control” described above with reference to FIG. 13.

In step S208, the processing of updating a reference value (original control value) is further executed (updating to a new control value).

The processing of steps S207 to S208 is repeated until it is determined in step S207 that the output is not necessary to be changed (original output=target output).

If it is determined in step S207 that the output is not necessary to be changed (original output=target output), the processing returns to step S201, and if the system utterance is being executed, the processing of step S202 and subsequent steps is repeated.

In this stage, in one example, if there is a change in values of the user distance, user utterance volume, ambient volume, or context information (context), a new control mode (target volume) is decided in step S206, and the control based on the new control mode (target volume) is executed in steps S207 to S208.

Moreover, the control target in step S208 is, in one example, the volume of system utterance, music, BGM, and the like.

For the system utterance, the contents of the system utterance are output to the display unit (the image output unit 125) in some cases.

In addition, the reference values (the new control values) updated in step S208 are volume levels or the like of a system utterance, music, BGM, or the like after updated or the like, and these values are stored in the storage unit (database) 111.

The reference value stored in the storage unit (database) 111 is used in subsequent processing under a similar environment. In other words, it is used for the volume control in a case of detecting similar context information (context).

Moreover, the output reference value registered in the storage unit (database) is a reference value for each volume such as system utterance, music, and BGM.

Each of these reference values is registered in the storage unit (database) 111 as reference values corresponding to a predetermined user distance, user utterance volume, ambient volume, and context information (context).

[5. Regarding Configuration Examples of Information Processing Apparatus and Information Processing System]

Although the plurality of embodiments has been described, the various processing functions described in these embodiments, for example, all the processing functions of the respective constituent elements of the information processing apparatus 100 illustrated in FIG. 3 can be also configured within one apparatus, for example, an agent device owned by a user, or an apparatus such as a smartphone and a PC, and some of the functions can be also configured to be executed in a server or the like.

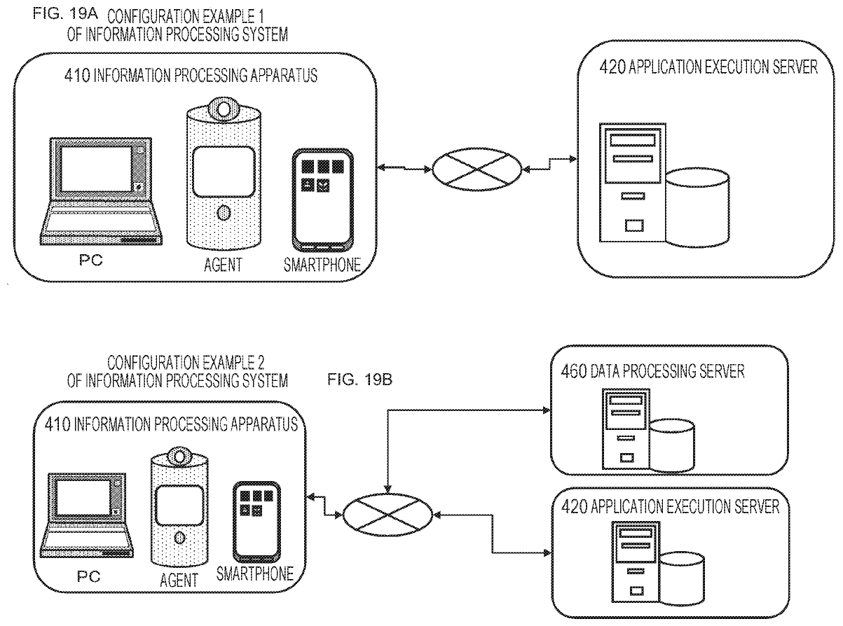

FIG. 19 illustrates a system configuration example.

Information processing system configuration example 1 in FIG. 19(1) is an example in which almost all the functions of the information processing apparatus illustrated in FIG. 3 are configured within one apparatus, for example, an information processing apparatus 410 which is a user terminal such as a smartphone or a PC owned by a user and an agent device having speech input/output and image input/output functions.

The information processing apparatus 410 corresponding to the user terminal executes communication with an application execution server 420 only in the case of using, for example, an external application at the time of generating a response sentence.

The application execution server 420 is, for example, a weather information providing server, a traffic information providing server, a medical information providing server, a sightseeing information providing server, or the like, and is constituted by a server group which can provide information to generate a response to a user utterance.

On the other hand, Information Processing System Configuration Example 2 in FIG. 19(2) is a system example in which some of the functions of the information processing apparatus illustrated in FIG. 3 are configured within the information processing apparatus 410, which is the user terminal such as the smartphone or the PC owned by the user, and the agent device, and the other functions are configured to be executed in a data processing server 460 capable of communicating with the information processing apparatus.

For example, it is possible to configured such that only the speech input unit 101, the image input unit 105, the sensor 107, the speech output unit 123, and the image output unit 125 in the apparatus illustrated in FIG. 3 are provided on the information processing apparatus 410 side of the user terminal, and all the other functions are executed on the server side, or the like.

Specifically, in one example, the system configuration can be constructed as follows.

The user terminal is provided with an output control unit configured to control the output of system utterance, music, BGM, or the like in addition to the speech input/output unit and the image input/output unit.

On the other hand, the data processing server has the utterance intention analysis unit configured to analyze the intention of the user utterance received from the user terminal.

The output control unit of the user terminal executes the output control such as volume control of a system response or the like based on the speech intention received from the server.

In one example, such a configuration is possible.

Note that various different settings are possible as a function division mode of functions on the user terminal side and functions on the server side. Furthermore, a configuration in which one function is executed on both the sides is also possible.

[6. Regarding Hardware Configuration Example of information Processing Apparatus]

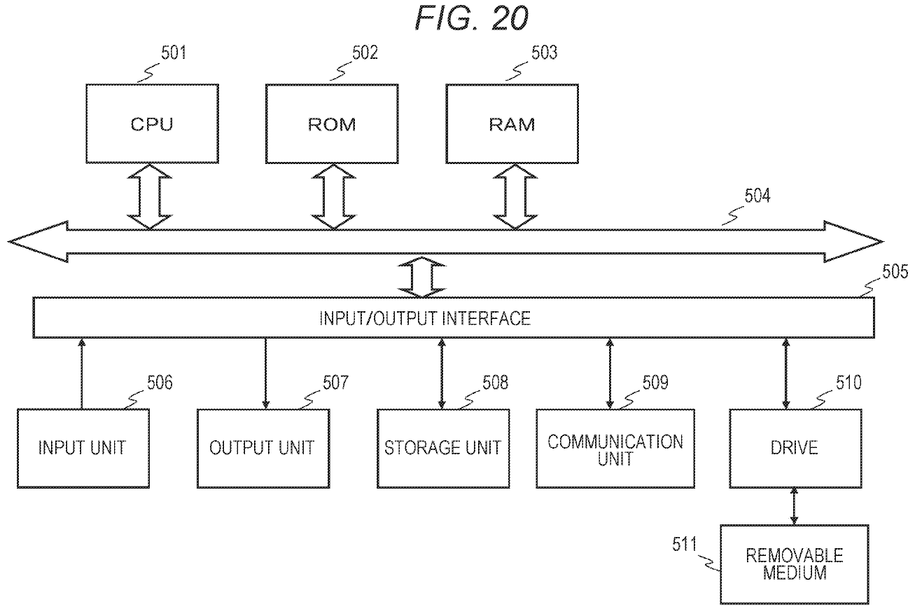

Next, a hardware configuration example of the information processing apparatus will be described with reference to FIG. 20.

The hardware to be described with reference to FIG. 20 is an example of a hardware configuration of the information processing apparatus that has been described above with reference to FIG. 3, and is an example of a hardware configuration of an information processing apparatus constituting the data processing server 460 that has been described with reference to FIG. 19.

A central processing unit (CPU) 501 functions as a control unit or a data processing unit that executes various processes according to a program stored in a read only memory (ROM) 502 or a storage unit 508. For example, the processing according to the sequence described in the above-described embodiments is performed. The program to be executed by the CPU 501, data, and the like are stored in a random access memory (RAM) 503. The CPU 501, the ROM 502, and the RAM 503 are mutually connected via a bus 504.

The CPU 501 is connected to an input/output interface 505 via the bus 504 and an input unit 506 including various switches, a keyboard, a mouse, a microphone, a sensor, and the like, and an output unit 507 including a display, a speaker, and the like are connected to the input/output interface 505. The CPU 501 executes various processes in response to an instruction input from the input unit 506, and outputs processing results to, for example, the output unit 507.

The storage unit 508 connected to the input/output interface 505 is configured using, for example, a hard disk and the like, and stores a program to be executed by the CPU 501 and various types of data. A communication unit 509 functions as a transmission/reception unit of Wi-Fi communication, Bluetooth (registered trademark) (BT) communication, and other data communication via a network such as the Internet and a local area network, and communicates with an external apparatus.

A drive 510 connected to the input/output interface 505 drives removable media 511 such as a magnetic disk, an optical disk, a magneto-optical disk, and a semiconductor memory such as a memory card, and executes data recording or reading.

[7. Summary of Configuration of Present Disclosure]

The embodiments of the present disclosure have been described in detail with reference to the specific embodiments. However, it is self-evident that those skilled in the art can make modifications and substitutions of the embodiments within a scope not departing from a gist of the present disclosure. In other words, the present invention has been disclosed in the form of exemplification, and should not be interpreted restrictively. In order to determine the gist of the present disclosure, the scope of claims should be taken into consideration.

Moreover, the technology disclosed in the specification herein may include the following configuration.

(1) An information processing apparatus including:

an output control unit configured to execute volume control of system utterance on the basis of a combination of a user distance and user utterance volume,

the user distance being a distance from the information processing apparatus to a user, and

the user utterance volume being calculated on the basis of user utterance input by the information processing apparatus.

(2) The information processing apparatus according to (1),

in which the output control unit executes control to increase a volume level of the system utterance

in a case where the user utterance volume is higher than ordinary volume corresponding to the user distance.

(3) The information processing apparatus according to (1) or (2),

in which the output control unit executes control to decrease a volume level of the system utterance

in a case where the user utterance volume is lower than ordinary volume corresponding to the user distance.

(4) The information processing apparatus according to any one of (1) to (3),

in which the output control unit executes the volume control of the system utterance depending on a volume level of an ambient sound other than the user utterance and

executes control to make a volume level of the system utterance higher than the volume level of the ambient sound.

(5) The information processing apparatus according to (4),

in which the output control unit executes control to maintain a difference between the volume level of the system utterance and the volume level of the ambient sound to be approximately constant.

(6) The information processing apparatus according to any one of (1) to (5),

in which the output control unit controls a volume level of the system utterance in response to a user request.

(7) The information processing apparatus according to any one of (1) to (6),

in which the output control unit executes volume control of music that is a system output other than the system utterance and

executes control to make a volume level of the system utterance higher than a volume level of the music.

(8) The information processing apparatus according to any one of (1) to (7),

in which the output control unit executes volume control of a volume level of the system utterance, a volume level of ordinary music, and a volume level of BGM music, and

executes control to make the volume level of the system utterance higher than the volume level of the ordinary music and

to make the volume level of the ordinary music higher than the volume level of the BGM music.

(9) The information processing apparatus according to any one of (1) to (8),

in which the output control unit executes the volume control of the system utterance corresponding to a time zone.

(10) The information processing apparatus according to any one of (1) to (9),

in which the output control unit executes control to output contents of the system utterance to a display unit in a case where a volume control value of the system utterance reaches a predefined maximum or minimum allowable value.

(11) The information processing apparatus according to any one of (1) to (10),

in which the output control unit acquires context information (context) of a space where the user is present and executes the volume control of the system utterance based on the context information (context).

(12) The information processing apparatus according to (11),

in which the context information (context) includes at least one of

a type of sound detected from a space where the user is present,

a number of persons in the space where the user is present, or

atmosphere of the space where the user is present.

(13) The information processing apparatus according to any one of (1) to (12),

in which the output control unit acquires a reference value that is an optimal volume level of the system utterance corresponding to the user distance, the user utterance volume, and ambient volume from a storage unit to execute the volume control based on the reference value.

(14) The information processing apparatus according to (13), in which the reference value is a user-specific reference value.

(15) An information processing system including: a user terminal; and a data processing server,

in which the user terminal includes

a speech input unit configured to input user utterance,

an output control unit configured to execute volume control of system utterance, and

a speech output unit configured to output the system utterance,

the data processing server includes

an utterance intention analysis unit configured to analyze intention of the user utterance received from the user terminal,

the user terminal outputs the system utterance depending on the intention of the user utterance through the speech output unit, and

the output control unit of the user terminal executes volume control of the system utterance on the basis of a combination of a user distance and a user utterance volume,

the user distance being a distance from the user terminal to a user, and

the user utterance volume being calculated on the basis of user utterance input through the speech input unit.

(16) An information processing method executed in an information processing apparatus including:

an output control unit configured to execute volume control of system utterance,

in which the output control unit executes the volume control of the system utterance on the basis of a combination of a user distance and a user utterance volume,

the user distance being a distance from the information processing apparatus to a user, and

the user utterance volume being calculated on the basis of user utterance input by the information processing apparatus.

(17) An information processing method executed in an information processing system including: a user terminal; and a data processing server,

in which the user terminal

inputs user utterance through a speech input unit and transmits the user utterance to the data processing server,

the data processing server

analyzes intention of the user utterance received from the user terminal and transmits a result obtained by the analysis to the user terminal,

the user terminal

executes processing of outputting system utterance corresponding to the intention of the user utterance through the speech output unit, and

the output control unit of the user terminal

executes volume control of the system utterance on the basis of a combination of a user distance and a user utterance volume,

the user distance being a distance from the user terminal to a user, and the user utterance volume being calculated on the basis of user utterance input through the speech input unit.

(18) A program causing an information processing apparatus to execute information processing, the apparatus including:

an output control unit configured to execute volume control of system utterance,

in which the program causes the output control unit to execute volume control of the system utterance on the basis of a combination of a user distance and a user utterance volume,

the user distance being a distance from the information processing apparatus to a user, and

the user utterance volume being calculated on the basis of user utterance input by the information processing apparatus.

Further, the series of processing described in the specification can be executed by hardware, software, or a complex configuration of the both. In a case where the processing is executed using software, it is possible to execute the processing by installing a program recording a processing sequence on a memory in a computer built into dedicated hardware or by installing a program in a general-purpose computer that can execute various processes. For example, the program can be recorded in a recording medium in advance. In addition to installing on a computer from the recording medium, it is possible to receive a program via a network, such as a local area network (LAN) and the Internet, and install the received program on a recording medium such as a built-in hard disk.

Note that various processes described in the specification not only are executed in a time-series manner according to the description but also may be executed in parallel or separately depending on the processing performance of an apparatus that executes the process or need. Furthermore, the term “system” in the present specification refers to a logical set configuration of a plurality of apparatuses, and is not limited to a system in which apparatuses of the respective configurations are provided in the same housing.

### INDUSTRIAL APPLICABILITY

As described above, the configuration of an embodiment of the present disclosure implements the apparatus and method capable of outputting the system utterance at optimal volume by controlling the system utterance volume on the basis of the user distance, the user utterance volume, the ambient volume, and the like.

Specifically, in one example, the output control unit controls the system utterance volume on the basis of a combination of the user distance that is a distance from the information processing apparatus to the user and the user utterance volume that is volume calculated on the basis of the user utterance input by the information processing apparatus. The system utterance volume is increased in the case where the user utterance volume is higher than the ordinary volume corresponding to the user distance, and the system utterance volume is decreased in the case where the user utterance volume is lower than the ordinary volume. In addition, control is performed to make the system utterance volume higher than the volume level of the ambient sound.

The present configuration achieves the apparatus and method capable of outputting the system utterance at the optimum volume by controlling the system utterance volume on the basis of the user distance, the user utterance volume, the ambient volume, and the like.

### REFERENCE SIGNS LIST

10 Information processing apparatus
11 Camera
12 Microphone
13 Display unit
14 Speaker
20 Server
30 External device
100 Information processing apparatus
101 Speech input unit
102 Speech separation unit
103 Speech recognition unit
104 Utterance semantic analysis unit
105 Image input unit
106 Image recognition unit
107 Sensor
108 Sensor information analysis unit
110 Output (speech or image) control unit
111 Storage unit (database)
120 Response generation unit
121 Non-system utterance speech (such as music and sound effect) generation/acquisition unit
122 System utterance speech synthesis unit
123 Speech output unit
124 Display image generation unit
125 Image output unit
410 Information processing apparatus
420 Application execution server
460 Data processing server
501 CPU
502 ROM
503 RAM
504 Bus
505 Input/output interface
506 Input unit
507 Output unit
508 Storage unit
509 Communication unit
510 Drive
511 Removable media

1. An information processing apparatus comprising:
an output control unit configured to execute volume control of system utterance on a basis of a combination of a user distance and user utterance volume,
the user distance being a distance from the information processing apparatus to a user, and
the user utterance volume being calculated on a basis of user utterance input by the information processing apparatus.

2. The information processing apparatus according to claim 1,
wherein the output control unit executes control to increase a volume level of the system utterance
in a case where the user utterance volume is higher than ordinary volume corresponding to the user distance.

3. The information processing apparatus according to claim 1,
wherein the output control unit executes control to decrease a volume level of the system utterance
in a case where the user utterance volume is lower than ordinary volume corresponding to the user distance.

4. The information processing apparatus according to claim 1,
wherein the output control unit executes the volume control of the system utterance depending on a volume level of an ambient sound other than the user utterance and
executes control to make a volume level of the system utterance higher than the volume level of the ambient sound.

5. The information processing apparatus according to claim 4,
wherein the output control unit executes control to maintain a difference between the volume level of the system utterance and the volume level of the ambient sound to be approximately constant.

6. The information processing apparatus according to claim 1,
wherein the output control unit controls a volume level of the system utterance in response to a user request.

7. The information processing apparatus according to claim 1,
wherein the output control unit executes volume control of music that is a system output other than the system utterance and
executes control to make a volume level of the system utterance higher than a volume level of the music.

8. The information processing apparatus according to claim 1,
wherein the output control unit executes volume control of a volume level of the system utterance, a volume level of ordinary music, and a volume level of BGM music, and
executes control to make the volume level of the system utterance higher than the volume level of the ordinary music and
to make the volume level of the ordinary music higher than the volume level of the BGM music.

9. The information processing apparatus according to claim 1,
wherein the output control unit executes the volume control of the system utterance corresponding to a time zone.

10. The information processing apparatus according to claim 1,
wherein the output control unit executes control to output contents of the system utterance to a display unit in a case where a volume control value of the system utterance reaches a predefined maximum or minimum allowable value.

11. The information processing apparatus according to claim 1,
wherein the output control unit acquires context information (context) of a space where the user is present and executes the volume control of the system utterance based on the context information (context).

12. The information processing apparatus according to claim 11,
wherein the context information (context) includes at least one of
a type of sound detected from a space where the user is present,
a number of persons in the space where the user is present, or
atmosphere of the space where the user is present.

13. The information processing apparatus according to claim 1,
wherein the output control unit acquires a reference value that is an optimal volume level of the system utterance corresponding to the user distance, the user utterance volume, and ambient volume from a storage unit to execute the volume control based on the reference value.

14. The information processing apparatus according to claim 13, wherein the reference value is a user-specific reference value.

15. An information processing system comprising: a user terminal; and a data processing server,
wherein the user terminal includes
a speech input unit configured to input user utterance,
an output control unit configured to execute volume control of system utterance, and
a speech output unit configured to output the system utterance,
the data processing server includes
an utterance intention analysis unit configured to analyze intention of the user utterance received from the user terminal,
the user terminal outputs the system utterance depending on the intention of the user utterance through the speech output unit, and
the output control unit of the user terminal executes volume control of the system utterance on a basis of a combination of a user distance and a user utterance volume,
the user distance being a distance from the user terminal to a user, and
the user utterance volume being calculated on a basis of user utterance input through the speech input unit.

16. An information processing method executed in an information processing apparatus comprising:
an output control unit configured to execute volume control of system utterance,
wherein the output control unit executes the volume control of the system utterance on a basis of a combination of a user distance and a user utterance volume,
the user distance being a distance from the information processing apparatus to a user, and
the user utterance volume being calculated on a basis of user utterance input by the information processing apparatus.

17. An information processing method executed in an information processing system comprising: a user terminal; and a data processing server,
wherein the user terminal
inputs user utterance through a speech input unit and transmits the user utterance to the data processing server,
the data processing server
analyzes intention of the user utterance received from the user terminal and transmits a result obtained by the analysis to the user terminal,
the user terminal
executes processing of outputting system utterance corresponding to the intention of the user utterance through the speech output unit, and
the output control unit of the user terminal executes volume control of the system utterance on a basis of a combination of a user distance and a user utterance volume,
the user distance being a distance from the user terminal to a user, and
the user utterance volume being calculated on a basis of user utterance input through the speech input unit.

18. A program causing an information processing apparatus to execute information processing, the apparatus comprising:
an output control unit configured to execute volume control of system utterance,
wherein the program causes the output control unit to execute volume control of the system utterance on a basis of a combination of a user distance and a user utterance volume,
the user distance being a distance from the information processing apparatus to a user, and
the user utterance volume being calculated on a basis of user utterance input by the information processing apparatus.
